(19) United States
(12) Patent Application Publication
(10) Pub. No.: US 2022/0314250 A1
(43) Pub. Date: Oct. 6, 2022

(54) METHOD FOR MANUFACTURING PILLAR-SHAPED HONEYCOMB STRUCTURE FILTER, AND PARTICLE ATTACHING DEVICE FOR PILLAR-SHAPED HONEYCOMB STRUCTURE

(71) Applicant: NGK INSULATORS, LTD., Nagoya-City (JP)

(72) Inventors: Yoshihiro SATO, Nissin-City (JP); Shuji UEDA, Nagoya-City (JP); Yuichi TAJIMA, Nagoya-City (JP); Seiya NAKANO, Nagoya-City (JP); Ken ITAZU, Tajimi-City (JP); Koichi SENDO, Nagoya-City (JP); Yutaka ISHII, Ama-Gun (JP)

(73) Assignee: NGK INSULATORS, LTD., Nagoya-City (JP)

(21) Appl. No.: 17/578,773

(22) Filed: Jan. 19, 2022

(30) Foreign Application Priority Data
Mar. 31, 2021 (JP) 2021-061933

(51) Int. Cl. B05B 7/14; B01D 46/00; B01D 46/24

(52) U.S. Cl. CPC B05B 7/1486; B01D 46/0001; B01D 46/249; B01D 46/2474; B05B 7/144; B01D 2279/30

(57) ABSTRACT

A method for manufacturing a pillar-shaped honeycomb structure filter including; attaching ceramic particles to a surface of the first cells by ejecting an aerosol including the ceramic particles toward the inlet side end surface from a direction perpendicular to the inlet side end surface while applying a suction force to the outlet side end surface to suck the ejected aerosol from the inlet side end surface, wherein the ejection of the aerosol is carried out using an aerosol generator including a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol.

### CROSS REFERENCE TO RELATED APPLICATIONS

The present invention claims the benefit of priority to Japanese Patent Application No 2021-061933 filed on Mar. 31, 2021 with the Japanese Patent Office, the entire contents of which are incorporated herein by reference in its entirety.

### FIELD OF THE INVENTION

The present invention relates to a method for manufacturing a pillar-shaped honeycomb structure filter. The present invention also relates to a particle attaching device for a pillar-shaped honeycomb structure.

### BACKGROUND OF THE INVENTION

Particulate matter (hereinafter referred to as PM) such as soot is contained in the exhaust gas discharged from the internal combustion engine such as a diesel engine and a gasoline engine. Soot is harmful to the human body and its emission is regulated. Currently, in order to comply with exhaust gas regulations, filters typified by DPF and GPF, which allow exhaust gas to pass through permeable partition walls with small pores and filter PM such as soot, are widely used.

As a filter for collecting PM, there is known a wall-flow type pillar-shaped honeycomb structure filter comprising a plurality of first cells extending in the height direction from an inlet side end surface to an outlet side end surface, opening on the inlet side end surface and having plugged portions on the outlet side end surface, and a plurality of second cells arranged adjacent to the first cells with partition walls interposed therebetween, extending in the height direction from the inlet side end surface to the outlet side end surface, having plugged portions on the inlet side end surface and opening on the outlet side end surface.

In recent years, with the tightening of exhaust gas regulations, stricter PM emission standards (PN regulation: particle matter number regulation) have been introduced, and high PM collection performance (PN high collection efficiency) is required for filters. Therefore, it has been proposed to form a layer for collecting PM (hereinafter, also referred to as “porous film” or “collection layer”) on the surface of the cells (Patent Literature 1 to 7). According to these patent documents, it is possible to collect PM while reducing the pressure loss by forming the porous film. As a method for forming the porous film, a method is adopted in which particles smaller than the average particle diameter of the particles constituting the partition walls are supplied to the inlet side end surface of the filter by a solid-gas two-phase flow and attached to the surface of the first cells, and then heat treatment is performed.

### CITATION LIST

### Patent Literature

[Patent Literature 1] WO 2010/110010
[Patent Literature 2] WO 2011/125768
[Patent Literature 3] WO 2011/125769
[Patent Literature 4] Japanese Patent No. 5863951
[Patent Literature 5] Japanese Patent Application Publication No. 2011-147931
[Patent Literature 6] Japanese Patent No. 5863950
[Patent Literature 7] Japanese Patent No. 5597148

### SUMMARY OF THE INVENTION

It is considered effective to form a porous film on the surface of the cells in order to improve the PM collection performance of the pillar-shaped honeycomb structure filter. However, according to the results of the study by the present inventors, it was found that in the conventional techniques for forming the porous film, the particles contained in the solid-gas two-phase flow supplied to the inlet side end surface of the filter are likely to aggregate. When the particles aggregate, it becomes difficult to attach the particles having the desired particle diameter distribution to the surface of the first cells, and the PM collection performance by the porous film may be adversely affected. Therefore, when carrying out the step of attaching the particles to the surface of the first cells, it is desirable from the viewpoint of quality control that the particles with suppressed aggregation be supplied to the inlet side end surface.

Accordingly, in one embodiment, it is an object of the present invention to provide a method for manufacturing a pillar-shaped honeycomb structure filter comprising a step of supplying particles with suppressed aggregation to the inlet side end surface of a pillar-shaped honeycomb structure and attaching the particles to the surface of the first cells. In addition, in another embodiment, it is an object of the present invention to provide a particle attaching device for a pillar-shaped honeycomb structure which is advantageous for carrying out a step of supplying particles with suppressed aggregation to the inlet side end surface of a pillar-shaped honeycomb structure and attaching the particles to the surface of the first cells.

As a result of diligent studies to solve the above problems, the present inventors have found that it is effective to suppress the aggregation of particles by ejecting an aerosol comprising ceramic particles toward the inlet side end surface of the pillar-shaped honeycomb structure using an aerosol generator having a predetermined configuration.

The present invention has been completed based on the above findings, and is exemplified as below.

[1]

A method for manufacturing a pillar-shaped honeycomb structure filter, comprising:

a step of preparing a pillar-shaped honeycomb structure comprising a plurality of first cells extending from an inlet side end surface to an outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, the plurality of first cells and the plurality of second cells alternately arranged adjacent to each other with a porous partition wall interposed therebetween, and

a step of attaching ceramic particles to a surface of the first cells by ejecting an aerosol comprising the ceramic particles toward the inlet side end surface from a direction perpendicular to the inlet side end surface while applying a suction force to the outlet side end surface to suck the ejected aerosol from the inlet side end surface;

wherein the ejection of the aerosol is carried out using an aerosol generator comprising a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol.

[2]

The method according to [1], wherein the ceramic particles in the aerosol have a median diameter (D50) of 1.0 to 6.0 μm in a volume-based cumulative particle diameter distribution measured by a laser diffraction/scattering method.

[3]

The production method according to [1] or [2], wherein as for the ceramic particles in the aerosol, in a volume-based particle diameter frequency distribution measured by the laser diffraction/scattering method, the ceramic particles of 10 μm or more is 20% by volume or less.

[4]

The method according to any one of [1] to [3], wherein

the aerosol ejected from the nozzle passes through a chamber provided between the nozzle and the inlet side end surface and is sucked from the inlet side end surface,

the chamber comprises an opposing surface to the inlet side end surface,

the opposing surface comprises an insertion port for the nozzle and one or more openings for taking in ambient gas into the chamber, and

the chamber comprises no openings for taking in ambient gas other than those on the opposing surface.

[5]

The method according to [4], wherein the surface of the chamber facing the inlet side end surface comprises a concentric closure portion centered on the insertion port, and the one or more openings are provided on an outer peripheral side of the closure portion.

[6]

The method according to any one of [1] to [5], wherein the aerosol generator further comprises:

a cylinder for accommodating the ceramic particles,

a piston or a screw for sending out the ceramic particles accommodated in the cylinder from a cylinder outlet, and

a loosening chamber comprising an inlet communicating with the cylinder outlet, a rotating body for loosening the ceramic particles sent out from the cylinder outlet, and an outlet communicating with the supply port.

[7]

The method according to any one of [1] to [5], wherein the aerosol generator further comprises:

a flow path for sucking and transporting the ceramic particles, which comprises an outlet communicating with the supply port, and

an accommodation unit for accommodating the ceramic particles and supplying the ceramic particles to the flow path for sucking and transporting;

wherein the drive gas flow path comprises on the way thereof a venturi portion where the flow path is narrowed, and the supply port is provided on the downstream side of the narrowest flow path location in the venturi portion.

[8]

The method according to any one of [1] to [5], wherein the aerosol generator further comprises:

a flow path for sucking and transporting the ceramic particles, which comprises an outlet communicating with the supply port,

a belt feeder for transporting the ceramic particles, and

a loosening chamber comprising an inlet for receiving the ceramic particles transported from the belt feeder, a rotating body for loosening the received ceramic particles, and an outlet communicating with the flow path for sucking and transporting.

[9]

The method according to any one of [1] to [8], wherein an end point of the step of attaching the ceramic particles to the surface of the first cells is determined based on a value of a differential pressure gauge installed for measuring a pressure loss between the inlet side end surface and the outlet side end surface of the pillar-shaped honeycomb structure.

[10]

The method according to any one of [1] to [8], wherein in the step of attaching the ceramic particles to the surface of the first cells, an average flow velocity of the aerosol flowing inside the pillar-shaped honeycomb structure is 5 m/s or more.

[11]

The method according to any one of [1] to [10], wherein a main component of the ceramic particles is silicon carbide, alumina, silica, cordierite or mullite.

[12]

A particle attaching device for a pillar-shaped honeycomb structure, comprising:

a holder for holding the pillar-shaped honeycomb structure comprising a plurality of first cells extending from an inlet side end surface to an outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, the plurality of first cells and the plurality of second cells alternately arranged adjacent to each other with a porous partition wall interposed therebetween,

a blower for applying a suction force to the outlet side end surface of the pillar-shaped honeycomb structure, and

an aerosol generator for ejecting an aerosol comprising ceramic particles toward the inlet side end surface from a direction perpendicular to the inlet side end surface and attaching the ceramic particles to a surface of the first cells;

wherein the aerosol generator comprises a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol.

[13]

The particle attaching device for a pillar-shaped honeycomb structure according to [12], further comprising a chamber provided between the nozzle and the inlet side end surface for guiding the aerosol through its interior, wherein

the chamber comprises an opposing surface to the inlet side end surface,

the opposing surface comprises an insertion port for the nozzle and one or more openings for taking in ambient gas into the chamber, and

the chamber comprises no openings for taking in ambient gas other than those on the opposing surface.

[14]

The particle attaching device for a pillar-shaped honeycomb structure according to [13], wherein the opposing surface comprises a concentric closure portion centered on the insertion port, and the one or more openings are provided on an outer peripheral side of the closure portion.

[15]

The particle attaching device for a pillar-shaped honeycomb structure according to any one of [12] to [14], wherein the aerosol generator further comprises:

a cylinder for accommodating the ceramic particles,

a piston or a screw for sending out the ceramic particles accommodated in the cylinder from a cylinder outlet, and

a loosening chamber comprising an inlet communicating with the cylinder outlet, a rotating body for loosening the ceramic particles sent out from the cylinder outlet, and an outlet communicating with the supply port.

[16]

The particle attaching device for a pillar-shaped honeycomb structure according to any one of [12] to [14], wherein the aerosol generator further comprises:

a flow path for sucking and transporting the ceramic particles, which comprises an outlet communicating with the supply port, and

an accommodation unit for accommodating the ceramic particles and supplying the ceramic particles to the flow path for sucking and transporting;

wherein the drive gas flow path comprises on the way thereof a venturi portion where the flow path is narrowed, and the supply port is provided on the downstream side of the narrowest flow path location in the venturi portion.

[17]

The particle attaching device for a pillar-shaped honeycomb structure according to any one of [12] to [14], wherein the aerosol generator further comprises:

a flow path for sucking and transporting the ceramic particles, which comprises an outlet communicating with the supply port,

a belt feeder for transporting the ceramic particles, and

a loosening chamber comprising an inlet for receiving the ceramic particles transported from the belt feeder, a rotating body for loosening the received ceramic particles, and an outlet communicating with the flow path for sucking and transporting.

According to the method for manufacturing a pillar-shaped honeycomb structure filter and the particle attaching device of one embodiment of the present invention, particles with suppressed aggregation can be supplied to the inlet side end surface of the pillar-shaped honeycomb structure. Therefore, it is possible to attach particles having a targeted particle diameter distribution to the surface of the first cells. Further, it is expected that the quality stability of the porous film formed by the heat treatment after the step of attaching the particles will be improved.

### BRIEF DESCRIPTION OF THE DRAWINGS

FIG. 1 is a perspective view schematically showing an example of a pillar-shaped honeycomb structure filter.

FIG. 2 is a schematic cross-sectional view when an example of a pillar-shaped honeycomb structure filter is observed from a cross-section parallel to the direction in which the cells extend.

FIG. 3 is a schematic partially enlarged view of a pillar-shaped honeycomb structure filter when observed from a cross-section orthogonal to the direction in which the cells extend.

FIG. 4A is a diagram schematically showing a first embodiment of an aerosol generator suitable for ejecting ceramic particles in which aggregation is suppressed.

FIG. 4B is a diagram schematically showing a second embodiment of an aerosol generator suitable for ejecting ceramic particles in which aggregation is suppressed.

FIG. 4C is a diagram schematically showing a third embodiment of an aerosol generator suitable for ejecting ceramic particles in which aggregation is suppressed.

FIG. 4D is a diagram schematically showing an aerosol generator according to a Comparative Example.

FIG. 5A is a schematic diagram for explaining a device configuration of a first embodiment of the particle attaching device according to an embodiment of the present invention.

FIG. 5B is a schematic diagram for explaining a device configuration of a second embodiment of the particle attaching device according to an embodiment of the present invention.

FIG. 5C is a schematic diagram for explaining a device configuration of a third embodiment of the particle attaching device according to an embodiment of the present invention.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### <1. Pillar-Shaped Honeycomb Structure Filter>

A pillar-shaped honeycomb structure filter according to one embodiment of the present invention will be described. A pillar-shaped honeycomb structure filter can be used as a DPF (Diesel Particulate Filter) or a GPF (Gasoline Particulate Filter) that collect soot, which is mounted on an exhaust gas line from a combustion device, typically an engine mounted on a vehicle. The pillar-shaped honeycomb structure filter according to the present invention can be installed in an exhaust pipe, for example.

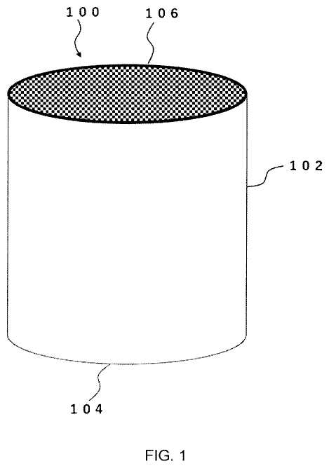

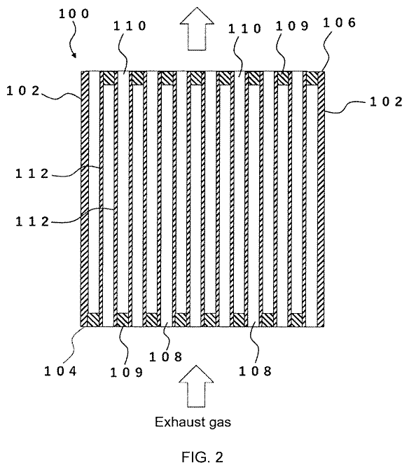

FIGS. 1 and 2 illustrate a schematic perspective view and a cross-sectional view of a pillar-shaped honeycomb structure filter (100), respectively. This pillar-shaped honeycomb structure filter (100) comprises an outer peripheral side wall (102), and a plurality of first cells (108) provided on the inner peripheral side of the outer peripheral side wall (102), the plurality of first cells (108) extending from a inlet side end surface (104) to an outlet side end surface (106), each opening on the inlet side end surface (104) and having a plugged portion (109) on the outlet side end surface (106), and a plurality of second cells (110) provided on the inner peripheral side of the outer peripheral side wall (102), the plurality of second cells (110) extending from the inlet side end surface (104) to the outlet side end surface (106), each having a plugged portion (109) on the inlet side end surface (104) and opening on the outlet side end surface (106). In this pillar-shaped honeycomb structure (100), since the first cells (108) and the second cells (110) are alternately arranged adjacent to each other with a porous partition wall (112) interposed therebetween, the inlet side end surface (104) and the outlet side end surface (106) each have a honeycomb shape.

When exhaust gas containing particulate matter (PM) such as soot is supplied to the inlet side end surface (104) which is on the upstream side of the pillar-shaped honeycomb structure filter (100), the exhaust gas is introduced into the first cells (108) and proceeds downstream in the first cells (108). Since the first cells (108) have plugged portions (109) on the outlet side end surface (106) which is on the downstream side, the exhaust gas penetrates through the porous partition walls (112) partitioning the first cells (108) and the second cells (110) and flows into the second cells (110). Since particulate matter cannot penetrate the partition walls (112), it is collected and deposited in the first cells (108). After the particulate matter is removed, the clean exhaust gas that has flowed into the second cells (110) proceeds downstream in the second cells (110) and flows out from the outlet side end surface (106) which is on the downstream side.

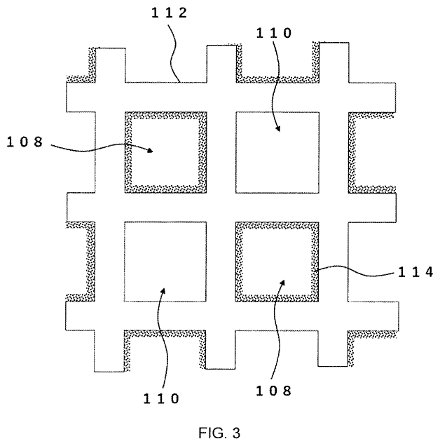

FIG. 3 shows a schematic partially enlarged view when the pillar-shaped honeycomb structure filter (100) is observed in a cross-section orthogonal to the direction in which the cells (108, 110) extend. On the surface of each of the first cells (108) (equivalent to the surfaces of the partition walls (112) partitioning the first cells (108)) of the pillar-shaped honeycomb structure filter (100), porous films (114) are formed.

In one embodiment, the porosity of the porous films (114) is higher than the porosity of the partition walls (112). When the porosity of the porous films (114) is higher than the porosity of the partition walls (112), there is an advantage that an increase in pressure loss can be suppressed. In this case, the difference between the porosity of the porous films (114) and the porosity (%) of the partition walls (112) is preferably 5% or more, and more preferably 10% or more. However, if the difference in porosity is too large, the collection efficiency of PM decreases, so the difference between the porosity (%) of the porous films (114) and the porosity (%) of the partition walls (112) is preferably 30% or less, and more preferably 25% or less.

The lower limit of the porosity of the porous films is preferably 60% or more, and more preferably 65% or more, from the viewpoint of suppressing an increase in pressure loss. In addition, the upper limit of the porosity of the porous film is preferably 85% or less, more preferably 80% or less, from the viewpoint of suppressing a decrease in the collection efficiency of PM.

The lower limit of the porosity of the partition walls is preferably 40% or more, more preferably 50% or more, and even more preferably 60% or more, from the viewpoint of suppressing the pressure loss of the exhaust gas. In addition, the upper limit of the porosity of the partition wall is preferably 80% or less, more preferably 75% or less, and even more preferably 70% or less, from the viewpoint of ensuring the strength of the pillar-shaped honeycomb structure filter.

The porosity of the porous films and the partition walls is measured as follows. An SEM (scanning electron microscope) image (dimension per field of view: 150 μm×150 μm) of a cross-section of the porous films (or partition walls) is photographed at a magnification of 1000 times or more, and an image processing software is used to perform binarization processing of the void portions and the solid portions. Next, the area ratio occupied by the void portions in the field of view is determined in arbitrary five or more fields of view, and the average value of the ratio is defined as the porosity (%) of the porous films (or partition walls).

In one embodiment, the average pore diameter of the porous films is 1.0 to 6.0 μm. The partition walls are also porous, but the average pore diameter of the partition walls is usually greater than 6.0 μm for the purpose of preventing excessive pressure loss. For this reason, by reducing the average pore diameter of the porous films formed on the surface of the partition walls to 1.0 to 6.0 μm, it is possible to improve the collection efficiency of PM while suppressing an increase in pressure loss when the exhaust gas passes through the partition walls. The average pore diameter of the porous films is preferably 2.0 to 5.0 μm, more preferably 3.0 to 4.0 μm.

The average pore diameter in the porous films and the partition walls is measured by the following method. An SEM (scanning electron microscope) image (dimension per field of view: 150 μm×150 μm) of a cross-section of the porous films (or partition walls) is photographed at a magnification of 1000 times or more, and an image processing software is used to perform binarization processing of the void portions and the solid portions. In the SEM image, a circle-equivalent diameter of each void constituting the void portions is measured using an image processing software and averaged to obtain the average pore diameter per field of view. The measurement of the average pore diameter is obtained from arbitrary five or more fields of view, and the average value thereof is defined as the measured value of the average pore diameter.

The porous film may be composed of ceramics. For example, the porous film may contain one or more ceramics selected from cordierite, silicon carbide (SiC), talc, mica, mullite, potsherd, aluminum titanate, alumina, silicon nitride, sialon, zirconium phosphate, zirconia, titania and silica. The main component of the porous films is preferably silicon carbide, alumina, silica, cordierite or mullite. Among these, it is preferable that the main component of the porous film be silicon carbide, because the presence of the surface oxide film (Si₂O) allows the porous film to be firmly bonded to each other and difficult to peel off. The main component of the porous film refers to a component that occupies 50% by mass or more of the porous film. SiC preferably accounts for 50% by mass or more, more preferably 70% by mass or more, and even more preferably 90% by mass or more of the porous film. The shape of the ceramics constituting the porous film is not particularly limited, and examples thereof include granular and fibrous forms.

Examples of the material constituting the porous partition walls and the outer peripheral side wall of the pillar-shaped honeycomb structure filter according to the present embodiment include, but are not limited to, porous ceramics. Examples of ceramics include cordierite, mullite, zirconium phosphate, aluminum titanate, silicon carbide (SiC), silicon-silicon carbide composite (for example, Si-bonded SiC), cordierite-silicon carbide composite, zirconia, spinel, indialite, sapphirine, corundum, titania, silicon nitride, and the like. As the ceramics, one type may be contained alone, or two or more types may be contained at the same time.

The pillar-shaped honeycomb structure filter may carry a PM combustion catalyst that assists PM combustion such as soot, an oxidation catalyst (DOC), a SCR catalyst and a NSR catalyst for removing nitrogen oxides (NOx), and a three-way catalyst that can remove hydrocarbon (HC), carbon monoxide (CO) and nitrogen oxides (NOx) at the same time. Various catalysts may also be carried on the pillar-shaped honeycomb structure filter according to the present embodiment.

The shape of the end surfaces of the pillar-shaped honeycomb structure filter is not limited, and it may be, for example, a round shape such as a circle, an ellipse, a race track shape, or an oval shape, or a polygon such as a triangle or a quadrangle. The pillar-shaped honeycomb structure (100) of FIG. 1 has a circular end surface and is cylindrical as a whole.

The height of the pillar-shaped honeycomb structure filter (the length from the inlet side end surface to the outlet side end surface) is not particularly limited and may be appropriately set according to the application and required performance. There is no particular limitation on the relationship between the height of the pillar-shaped honeycomb structure filter and the maximum diameter of each end surface (referring to the maximum length of the diameters passing through the center of gravity of each end surface of the pillar-shaped honeycomb structure filter). Therefore, the height of the pillar-shaped honeycomb structure filter may be longer than the maximum diameter of each end surface, or the height of the pillar-shaped honeycomb structure filter may be shorter than the maximum diameter of each end surface.

The shape of the cells in the cross-section perpendicular to the flow path direction of the cells is not limited, but is preferably a quadrangle, a hexagon, an octagon, or a combination thereof. Among these, squares and hexagons are preferred. By making the shape of the cells in this way, it is possible to reduce the pressure loss when a fluid passes through the pillar-shaped honeycomb structure.

The upper limit of the average thickness of the partition walls in the pillar-shaped honeycomb structure filter is preferably 0.238 mm or less, more preferably 0.228 mm or less, and even more preferably 0.220 mm or less, from the viewpoint of suppressing the pressure loss. However, from the viewpoint of ensuring the strength of the pillar-shaped honeycomb structure filter, the lower limit of the average thickness of the partition walls is preferably 0.194 mm or more, more preferably 0.204 mm or more, and even more preferably 0.212 mm or more. In the present specification, the thickness of the partition wall refers to a crossing length of a line segment that crosses the partition wall when the centers of gravity of adjacent cells are connected by this line segment in a cross-section perpendicular to the direction in which the cells extend. The average thickness of partition walls refers to the average value of the thickness of all partition walls.

The cell density (number of cells per unit cross-sectional area perpendicular to the direction in which the cells extend) is not particularly limited, but may be, for example, 6 to 2000 cells/square inch (0.9 to 311 cells/cm²), more preferably 50 to 1000 cells/square inch (7.8 to 155 cells/cm²), particularly preferably 100 to 400 cells/square inch (15.5 to 62.0 cells/cm²).

The pillar-shaped honeycomb structure filter can be provided as an integrally formed product. Further, the pillar-shaped honeycomb structure filter can also be provided as a segment joint body by joining and integrating a plurality of pillar-shaped honeycomb structure filter segments at their side surfaces, each having an outer peripheral side wall. By providing the pillar-shaped honeycomb structure filter as a segment joint body, the thermal shock resistance can be enhanced.

### <2. Method for Manufacturing Pillar-Shaped Honeycomb Structure Filter>

A method for manufacturing a pillar-shaped honeycomb structure filter will be exemplified as below. First, a green body is formed by kneading a raw material composition comprising a ceramic raw material, a dispersion medium, a pore-forming material, and a binder. Next, the green body is subject to extrusion molding to prepare a pillar-shaped honeycomb formed body as desired. Additives such as a dispersant can be added to the raw material composition as needed. For extrusion molding, a die having a desired overall shape, cell shape, partition wall thickness, cell density and the like can be used.

After the pillar-shaped honeycomb formed body is dried, plugged portions are formed at predetermined positions on both end surfaces of the pillar-shaped honeycomb formed body, and then the plugged portions are dried to obtain a pillar-shaped honeycomb formed body having the plugged portions. After that, by degreasing and firing the pillar-shaped honeycomb formed body, a pillar-shaped honeycomb structure is obtained. After that, by forming porous films on the surface of the first cells of the pillar-shaped honeycomb structure, a pillar-shaped honeycomb structure filter is obtained.

A ceramic raw material is a raw material remaining after firing and constituting a portion of the skeleton of the honeycomb structure as ceramics. As the ceramic raw material, a raw material capable of forming the above-mentioned ceramics after firing can be used. The ceramic raw material can be provided, for example, in the form of powder. Examples of the ceramic raw material include a raw material for obtaining ceramics such as cordierite, mullite, zircon, aluminum titanate, silicon carbide, silicon nitride, zirconia, spinel, indialite, sapphirine, corundum, titania, and the like. Specific examples thereof include, but are not limited to, silica, talc, alumina, kaolin, serpentine, pyrophyllite, brucite, boehmite, mullite, magnesite, aluminum hydroxide, and the like. As the ceramic raw material, one type may be used alone, or two or more types may be used in combination.

In the case of filter applications such as DPF and GPF, cordierite can be preferably used as the ceramics. In this case, a cordierite-forming raw material can be used as the ceramic raw material. A cordierite-forming raw material is a raw material that becomes cordierite by firing. It is desirable that the cordierite-forming raw material has a chemical composition of alumina (Al₂O₃) (including the amount of aluminum hydroxide that converts to alumina): 30 to 45% by mass, magnesia (MgO): 11 to 17% by mass, and silica (SiO₂): 42 to 57% by mass.

Examples of the dispersion medium include water or a mixed solvent of water with an organic solvent such as alcohol, and water can be particularly preferably used.

The pore-forming material is not particularly limited as long as it becomes pores after firing, and examples thereof include, wheat flour, starch, foamed resin, water-absorbing resin, porous silica, carbon (for example, graphite), ceramic balloon, polyethylene, polystyrene, polypropylene, nylon, polyester, acrylic and phenol, and the like. As the pore-forming material, one type may be used alone, or two or more types may be used in combination. From the viewpoint of increasing the porosity of the fired body, the amount of the pore-forming material is preferably 0.5 parts by mass or more, more preferably 2 parts by mass or more, and even more preferably 3 parts by mass or more with respect to 100 parts by mass of the ceramic raw material. From the viewpoint of ensuring the strength of the fired body, the amount of the pore-forming material is preferably 10 parts by mass or less, more preferably 7 parts by mass or less, and even more preferably 4 parts by mass or less with respect to 100 parts by mass of the ceramic raw material.

Examples of the binder include organic binders such as methyl cellulose, hydroxypropyl methyl cellulose, hydroxyethyl cellulose, carboxymethyl cellulose, and polyvinyl alcohol. In particular, it is preferable to use methyl cellulose and hydroxypropyl methyl cellulose in combination. Further, from the viewpoint of increasing the strength of the honeycomb formed body, the amount of the binder is preferably 4 parts by mass or more, more preferably 5 parts by mass or more, and even more preferably 6 parts by mass or more with respect to 100 parts by mass of the ceramic raw material. From the viewpoint of suppressing the occurrence of cracking due to abnormal heat generation in the firing step, the amount of the binder is preferably 9 parts by mass or less, more preferably 8 parts by mass or less, and even more preferably 7 parts by mass or less with respect to 100 parts by mass of the ceramic raw material. As the binder, one type may be used alone, or two or more types may be used in combination.

As the dispersant, ethylene glycol, dextrin, fatty acid soap, polyether polyol and the like can be used. As the dispersant, one type may be used alone, or two or more types may be used in combination. The content of the dispersant is preferably 0 to 2 parts by mass with respect to 100 parts by mass of the ceramic raw material.

The method for plugging the end surfaces of the pillar-shaped honeycomb formed body is not particularly limited, and a known method can be adopted. The material of the plugged portion is not particularly limited, but ceramics are preferable from the viewpoint of strength and heat resistance. As the ceramics, it is preferably a ceramic material comprising at least one selected from the group consisting of cordierite, mullite, zircon, aluminum titanate, silicon carbide, silicon nitride, zirconia, spinel, indialite, sapphirine, corundum, and titania. It is even more preferable that the plugged portion have the same material composition as the main body portion of the honeycomb formed body because the expansion coefficient upon firing can be the same so that the durability is improved.

After drying the honeycomb formed body, a pillar-shaped honeycomb structure can be manufactured by performing degreasing and firing. As for the conditions of the drying process, the degreasing process, and the firing process, known conditions may be adopted according to the material composition of the honeycomb formed body, and no particular explanation is required. However, specific examples of the conditions are given below.

In the drying process, conventionally known drying methods such as hot gas drying, microwave drying, dielectric drying, reduced-pressure drying, vacuum drying, and freeze drying can be used. Among these, a drying method that combines hot gas drying with microwave drying or dielectric drying is preferable in that the entire formed body can be dried quickly and uniformly.

When forming the plugged portions, it is preferable to form the plugged portions on both end surfaces of the dried honeycomb formed body and then dry the plugged portions. The plugged portions are formed at predetermined positions such that a plurality of first cells extending from the inlet side end surface to the outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, are alternately arranged adjacent to each other with a porous partition wall interposed therebetween.

Next, the degreasing process will be described. The combustion temperature of the binder is about 200° C., and the combustion temperature of the pore-forming material is about 300 to 1000° C. Therefore, the degreasing process may be carried out by heating the honeycomb formed body in the range of about 200 to 1000° C. The heating time is not particularly limited, but is normally about 10 to 100 hours. The honeycomb formed body after the degreasing step is called a calcined body.

The firing process depends on the material composition of the honeycomb formed body, but can be performed, for example, by heating the calcined body to 1350 to 1600° C. and holding it for 3 to 10 hours. In this way, a pillar-shaped honeycomb structure comprising a plurality of first cells extending from the inlet side end surface to the outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, the plurality of first cells and the plurality of second cells being alternately arranged adjacent to each other with a porous partition wall interposed therebetween can be prepared.

Next, a porous film is formed on the surface of the first cells of the pillar-shaped honeycomb structure that has undergone the firing process. First, a step of attaching ceramic particles to a surface of the first cells by ejecting an aerosol comprising the ceramic particles toward the inlet side end surface, preferably toward the center of the inlet side end surface, from a direction perpendicular to the inlet side end surface while applying a suction force to the outlet side end surface to suck the ejected aerosol from the inlet side end surface is carried out. As an example, the distance between the aerosol ejection nozzle and the inlet side end surface can be 500 mm to 2000 mm, and the aerosol ejection velocity can be 2 to 80 m/s.

It is desirable that the ceramic particles in the aerosol have little aggregation. Specifically, as for the ceramic particles in the aerosol, in a volume-based particle diameter frequency distribution measured by a laser diffraction/scattering method, the ceramic particles of 10 μm or more are preferably 20% by volume or less, more preferably 18% by volume or less, and even more preferably 15% by volume or less. By suppressing the aggregation of the ceramic particles in the aerosol, it becomes possible to attach the ceramic particles having a target particle diameter distribution to the surface of the first cells, and the quality stability can be improved. Further, since the aggregation is suppressed, it becomes easy to attach fine ceramic particles, so that it is possible to reduce the average pore diameter of the porous films.

As for the ceramic particles in the aerosol, in a volume-based cumulative particle diameter distribution measured by a laser diffraction/scattering method, the median diameter (D50) is preferably 1.0 to 6.0 μm, more preferably 2.0 to 5.0 μm. By ejecting extremely fine ceramic particles, it is possible to increase the porosity while reducing the average pore diameter of the obtained porous films.

As the ceramic particles, the above-mentioned ceramic particles constituting the porous film are used. For example, ceramic particles comprising one or two or more selected from the group consisting of cordierite, silicon carbide (SiC), talc, mica, mullite, potsherd, aluminum titanate, alumina, silicon nitride, sialon, zirconium phosphate, zirconia, titania and silica can be used. The main component of the ceramic particles is preferably silicon carbide, alumina, silica, cordierite or mullite. The main component of the ceramic particles refers to a component that occupies 50% by mass or more of the ceramic particles. The ceramic particles preferably comprise 50% by mass or more, more preferably 70% by mass or more, and even more preferably 90% by mass or more of SiC.

In order to suppress the aggregation of ceramic particles, it is advantageous to carry out the aerosol ejection using an aerosol generator comprising a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol. In one embodiment, the supply port can be configured such that the ceramic particles are introduced into the drive gas flow path from a direction substantially perpendicular to the flow direction of the drive gas flowing through the drive gas flow path.

At the time when the ceramic particles are introduced into the drive gas flow path, the ceramic particles may be aggregated. In particular, fine ceramic particles have a tendency to aggregate. However, when the ceramic particles are supplied from the outer peripheral side of the drive gas flow path toward the inside of the drive gas flow path, a loosening effect by the drive gas on the ceramic particles becomes high, so it is presumed that the ceramic particles with suppressed aggregation can be ejected from the nozzle of the aerosol generator.

### (First Embodiment of Aerosol Generator)

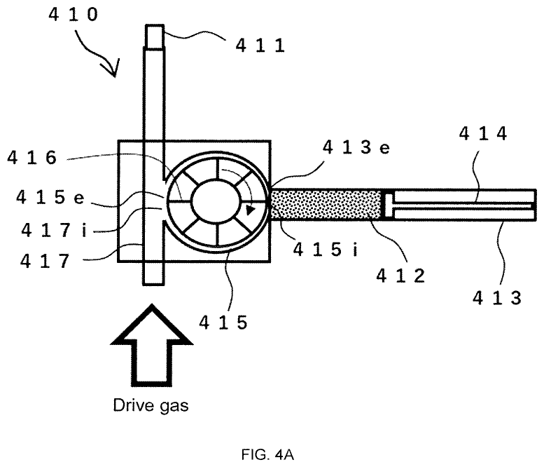

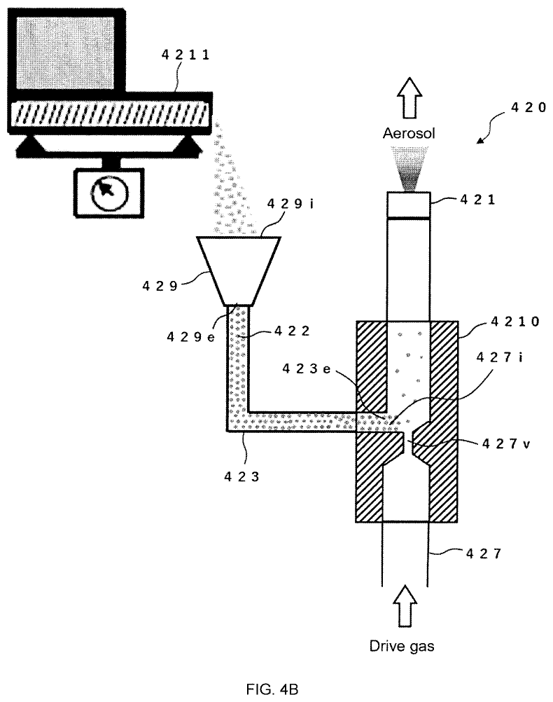

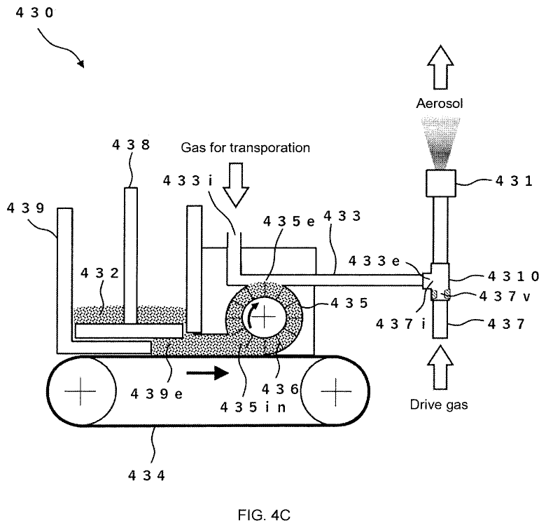

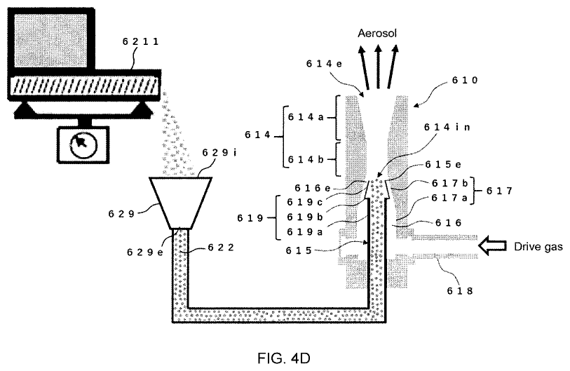

FIG. 4A schematically shows a first embodiment of an aerosol generator (410) suitable for ejecting ceramic particles in which aggregation is suppressed.

The aerosol generator (410) comprises:

a drive gas flow path (417) for flowing a pressurized drive gas,

a supply port (417i) provided on the way of the drive gas flow path (417) and capable of sucking the ceramic particles (412) from an outer peripheral side of the drive gas flow path (417) toward an inside of the drive gas flow path (417),

a nozzle (411) attached to a tip of the drive gas flow path (417) and capable of ejecting the aerosol,

a cylinder (413) for accommodating the ceramic particles (412),

a piston or a screw (414) for sending out the ceramic particles (412) accommodated in the cylinder (413) from a cylinder outlet (413e), and

a loosening chamber (415) comprising an inlet (415i) communicating with the cylinder outlet (413e), a rotating body (416) for loosening the ceramic particles (412) sent out from the cylinder outlet (413e), and an outlet (415e) communicating with the supply port (417i).

The aerosol generator (410) can eject aerosol from the nozzle (411). Ceramic particles (412) adjusted to a predetermined particle diameter distribution are accommodated in the cylinder (413). The ceramic particles (412) accommodated in the cylinder (413) are pushed out from the cylinder outlet (413e) by a piston or a screw (414). The piston or screw (414) can be configured to be able to adjust the discharging rate of the ceramic particles (412). The ceramic particles (412) discharged from the cylinder outlet (413e) enter the loosening chamber (415) via the inlet (415i). In this embodiment, the cylinder outlet (413e) and the inlet (415i) are in common.

The ceramic particles (412) introduced into the loosening chamber (415) move in the loosening chamber (415) while being loosened by the rotating body (416), and are discharged from the loosening chamber outlet (415e). As the rotating body (416), for example, a rotating brush can be adopted. The rotating body (416) can be driven by a motor, and can be configured to control its rotation speed.

The ceramic particles (412) discharged from the loosening chamber outlet (415e) are sucked into the drive gas flow path (417) from the outer peripheral side of the drive gas flow path (417) via the supply port (417i). In the present embodiment, the loosening chamber outlet (415e) and the supply port (417i) are in common. Further, in the present embodiment, the ceramic particles (412) are introduced into the drive gas flow path (417) from a direction substantially perpendicular to the flow direction of the drive gas flowing through the drive gas flow path (417). The ceramic particles (412) supplied into the drive gas flow path (417) collide with the drive gas flowing through the drive gas flow path (417), and are mixed while being loosened to form an aerosol, and are ejected from the nozzle (411). In the present embodiment, the ceramic particles (412) loosened by passing through the loosening chamber (415) are introduced from the supply port (417i) into the drive gas flow path (417). Therefore, in addition to the effect of loosening the ceramic particles (412) by the collision with the drive gas, the effect of loosening the ceramic particles (412) in the loosening chamber (415) can be obtained, so a high aggregation suppressing effect can be obtained. The nozzle (411) is preferably installed at a position and orientation in which the aerosol is ejected in a direction perpendicular to the inlet side end surface of the pillar-shaped honeycomb structure. More preferably, the nozzle (411) is installed at a position and orientation in which the aerosol is ejected in a direction perpendicular to the inlet side end surface toward the center of the inlet side end surface.

By using a compressed gas such as compressed air whose pressure has been adjusted as the drive gas, the ejection flow rate of the aerosol from the nozzle (411) can be controlled. As the drive gas, it is preferable to use dry air (for example, with a dew point of 10° C. or less) in order to suppress the aggregation of the ceramic particles. In the present specification, the “dew point” refers to a value measured by a polymer-type capacitive dew point meter in accordance with JIS Z8806: 2001.

The lower limit of the flow velocity of the drive gas immediately before the drive gas passes through the supply port (417i) of the drive gas flow path (417) is preferably 9 m/s or more, more preferably 10 m/s or more, and even more preferably 11 m/s or more, from the viewpoint of increasing the loosening force of the ceramic particles. The upper limit of the flow velocity of the drive gas immediately before the drive gas passes through the supply port (417i) of the drive gas flow path (417) is not particularly set, but is usually 15 m/s or less, and is typically 13 m/s or less. If necessary, the drive gas flow path (417) may be provided with a venturi portion, which will be described later, on the upstream side of the supply port (417i).

Fine ceramic particles have a property of easily aggregating. However, by using the aerosol generator (410) according to the present embodiment, it is possible to eject ceramic particles having a target particle diameter distribution in which aggregation is suppressed.

### (Second Embodiment of Aerosol Generator)

FIG. 4B schematically shows a second embodiment of an aerosol generator (420) suitable for ejecting ceramic particles in which aggregation is suppressed.

The aerosol generator (420) comprises:

a drive gas flow path (427) for flowing a pressurized drive gas,

a supply port (427i) provided on the way of the drive gas flow path (427) and capable of sucking the ceramic particles (422) from an outer peripheral side of the drive gas flow path (427) toward an inside of the drive gas flow path (427),

a nozzle (421) attached to a tip of the drive gas flow path (427) and capable of ejecting the aerosol,

a flow path (423) for sucking and transporting the ceramic particles (422), which comprises an outlet (423e) communicating with the supply port (427i), and

an accommodation unit (429) for accommodating the ceramic particles (422) and supplying the ceramic particles (422) to the flow path (423) for sucking and transporting.

For example, a funnel can be used for the accommodation unit (429). Ceramic particles adjusted to a predetermined particle diameter distribution are accommodated in the accommodation unit (429). The ceramic particles (422) accommodated in the accommodation unit (429) receive the suction force from the drive gas flow path (427) and flow through the outlet (429e) provided at the bottom of the accommodation unit (429). After being transported to the outlet (423e) through the flow path (423), it is introduced into the drive gas flow path (427) from the supply port (427i). At this time, the ambient gas (typically air) sucked from the inlet (429i) of the accommodation unit inlet is also introduced into the drive gas flow path (427) through the flow path (423) together with the ceramic particles (422). In the present embodiment, the outlet (423e) and the supply port (427i) are in common. Further, in the present embodiment, the ceramic particles (422) are introduced into the drive gas flow path (427) from a direction substantially perpendicular to the flow direction of the drive gas flowing through the drive gas flow path (427).

The ceramic particles (422) supplied into the drive gas flow path (427) collide with the drive gas flowing through the drive gas flow path (427), and are mixed while being loosened to form an aerosol, and are ejected from the nozzle (421). The nozzle (421) is preferably installed at a position and orientation in which the aerosol is ejected in a direction perpendicular to the inlet side end surface of the pillar-shaped honeycomb structure. More preferably, the nozzle (421) is installed at a position and orientation in which the aerosol is ejected in a direction perpendicular to the inlet side end surface toward the center of the inlet side end surface.

The supply of the ceramic particles (422) to the accommodation unit (429) is not limited, but is preferably carried out using, for example, a powder metering feeder (4211) such as a screw feeder and a belt conveyor. The ceramic particles (422) discharged from the powder metering feeder (4211) can be dropped into the accommodation unit (429) by gravity.

In a preferred embodiment, the drive gas flow path (427) comprises on the way thereof a venturi portion (427v) where the flow path is narrowed, and the supply port (427i) is provided on the downstream side of the narrowest flow path location in the venturi portion (427v). If the drive gas flow path (427) has a venturi portion (427v), the speed of the drive gas passing through the venturi portion (427v) increases. Therefore, drive gas with higher speed can be made to collide with the ceramic particles (422) supplied downstream of the venturi portion (427v), so that the loosening force is improved. In order to increase the loosening force of the drive gas, it is more preferable that the supply port (427i) be provided on the downstream side of the narrowest flow path location in the venturi portion (427v) and adjacent to this location. The configuration can be realized, for example, by connecting the drive gas flow path (427) and the flow path (423) for sucking and transporting by using a venturi ejector (4210).

The lower limit of the flow velocity of the drive gas immediately before passing through the venturi portion (427v) is preferably 13 m/s or more, more preferably 20 m/s or more, and even more preferably 26 m/s or more, from the viewpoint of increasing the loosening force to the ceramic particles. The upper limit of the flow velocity of the drive gas immediately before passing through the venturi portion (427v) is not particularly set, but is usually 50 m/s or less, and is typically 40 m/s or less.

The lower limit of a ratio of the flow path cross-sectional area immediately before the venturi portion to the flow path cross-sectional area of the venturi portion is preferably 8 or more, and more preferably 16 or more, from the viewpoint of increasing the loosening force. The upper limit of the ratio of the flow path cross-sectional area immediately before the venturi portion to the flow path cross-sectional area of the venturi portion is not particularly limited, but if it is too large, the pressure loss at the venturi portion increases, so that it is preferably 64 or less, and more preferably 32 or less. Here, the flow path cross-sectional area of the venturi portion means the flow path cross-sectional area of the narrowest flow path location in the venturi portion. Further, the flow path cross-sectional area immediately before the venturi portion means the flow path cross-sectional area on the upstream side of the venturi portion immediately before the flow path narrows.

With the use of the venturi ejector (4210), for example, when the drive gas passes through the drive gas flow path (427), a large suction force can be applied to the flow path (423) for sucking and transporting, and it is possible to prevent the flow path (423) for sucking and transporting from being clogged by the ceramic particles (422). The venturi ejector (4210) is also effective as a means for removing the ceramic particles (422) when the flow path (423) for sucking and transporting is clogged with the ceramic particles (422).

By using a compressed gas such as compressed air whose pressure has been adjusted as the drive gas, the ejection flow rate of the aerosol from the nozzle (421) can be controlled. As the drive gas, it is preferable to use dry air (for example, with a dew point of 10° C. or less) in order to suppress the aggregation of the ceramic particles.

Fine ceramic particles have a property of easily aggregating. However, by using the aerosol generator (420) according to the present embodiment, it is possible to eject ceramic particles having a target particle diameter distribution with suppressed aggregation.

### (Third Embodiment of Aerosol Generator)

FIG. 4C schematically shows a third embodiment of an aerosol generator (430) suitable for ejecting ceramic particles in which aggregation is suppressed.

The aerosol generator (430) comprises:

a drive gas flow path (437) for flowing a pressurized drive gas,

a supply port (437i) provided on the way of the drive gas flow path (437) and capable of sucking the ceramic particles (432) from an outer peripheral side of the drive gas flow path (437) toward an inside of the drive gas flow path (437),

a nozzle (431) attached to a tip of the drive gas flow path (437) and capable of ejecting the aerosol,

a flow path (433) for sucking and transporting the ceramic particles (432), which comprises an outlet (433e) communicating with the supply port (437i),

a belt feeder (434) for transporting the ceramic particles (432), and

a loosening chamber (435) comprising an inlet (435in) for receiving the ceramic particles (432) transported from the belt feeder (434), a rotating body (436) for loosening the received ceramic particles (432), and an outlet (435e) communicating with the flow path (433) for sucking and transporting.

The aerosol generator (430) may have an accommodation unit (439) such as a container for accommodating the ceramic particles (432). Ceramic particles adjusted to a predetermined particle diameter distribution are accommodated in the accommodation unit (439). The ceramic particles (432) in the accommodation unit (439) are stirred by the stirrer (438). As a result, there is an advantage that the ceramic particles which easily cause bridging can be stably discharged from the discharge port (439e). A discharge port (439e) for ceramic particles (432) is provided at the bottom of the accommodation unit (439). The ceramic particles (432) discharged from the discharge port (439e) are transported to the inlet (435in) of the loosening chamber (435) by the belt feeder (434). The transport speed of the ceramic particles (432) can be adjusted by controlling the belt speed of the belt feeder (434).

The ceramic particles (432) introduced into the loosening chamber (435) move in the loosening chamber (435) while being loosened by the rotating body (436), and are discharged from the loosening chamber outlet (435e). As the rotating body (436), for example, a rotating brush can be adopted. The rotating body (436) can be driven by a motor, and can be configured to control its rotation speed.

In response to the suction force from the drive gas flow path (437), the transport gas for the ceramic particles (432) is sucked from the inlet (433i) of the flow path (433) for sucking and transporting. As the transport gas, ambient gas such as air may be used, but it is preferable to use dry air (for example, with a dew point of 10° C. or less) in order to suppress the aggregation of the ceramic particles. Further, the transport gas may be transported only by the suction force from the drive gas flow path (437), or may be pumped by using a compressor or the like. The ceramic particles (432) discharged from the loosening chamber outlet (435e) are entrained by the transport gas flowing through the flow path (433) and transported to the outlet (433e), and then introduced into the drive gas flow path (437) via the supply port (437i). In the present embodiment, the outlet (433e) and the supply port (437i) are in common. Further, in the present embodiment, the ceramic particles (432) are introduced into the drive gas flow path (437) from a direction substantially perpendicular to the flow direction of the drive gas flowing through the drive gas flow path (437).

The ceramic particles (432) supplied into the drive gas flow path (437) together with the transport gas collide with the drive gas flowing through the drive gas flow path (437), and are mixed while being loosened to form an aerosol, and are ejected from the nozzle (431). In the present embodiment, the ceramic particles (432) loosened by passing through the loosening chamber (435) are introduced into the drive gas flow path (437) via the supply port (437i). Therefore, in addition to the effect of loosening the ceramic particles (432) by the drive gas, the effect of loosening the ceramic particles (412) by the loosening chamber (435) can be obtained, so a high aggregation suppressing effect can be obtained. The nozzle (431) is preferably installed at a position and orientation in which the aerosol is ejected in a direction perpendicular to the inlet side end surface of the pillar-shaped honeycomb structure. More preferably, the nozzle (431) is installed at a position and orientation in which the aerosol is ejected in a direction perpendicular to the inlet side end surface toward the center of the inlet side end surface.

In a preferred embodiment, the drive gas flow path (437) comprises on the way thereof a venturi portion (437v) where the flow path is narrowed, and the supply port (437i) is provided on the downstream side of the narrowest flow path location in the venturi portion (437v). In order to increase the loosening force of the drive gas, it is more preferable that the supply port (437i) be provided on the downstream side of the narrowest flow path location in the venturi portion (437v) and adjacent to this location. If the drive gas flow path (437) has a venturi portion (437v), the speed of the drive gas passing through the venturi portion (437v) increases. Therefore, drive gas with higher speed can be made to collide with the ceramic particles (432) supplied downstream of the venturi portion (437v), so that the loosening force is improved. The configuration can be realized, for example, by connecting the drive gas flow path (437) and the flow path (433) for sucking and transporting by using a venturi ejector (4310).

The lower limit of the flow velocity of the drive gas immediately before passing through the venturi portion (437v) is preferably 13 m/s or more, more preferably 20 m/s or more, and even more preferably 26 m/s or more, from the viewpoint of increasing the loosening force to the ceramic particles. The upper limit of the flow velocity of the drive gas immediately before passing through the venturi portion (437v) is not particularly set, but is usually 50 m/s or less, and is typically 40 m/s or less.

The lower limit of a ratio of the flow path cross-sectional area immediately before the venturi portion to the flow path cross-sectional area of the venturi portion is preferably 8 or more, and more preferably 16 or more, from the viewpoint of increasing the loosening force. The upper limit of the ratio of the flow path cross-sectional area immediately before the venturi portion to the flow path cross-sectional area of the venturi portion is not particularly limited, but if it is too large, the pressure loss at the venturi portion increases, so that it is preferably 64 or less, and more preferably 32 or less. Here, the flow path cross-sectional area of the venturi portion means the flow path cross-sectional area of the narrowest flow path location in the venturi portion. Further, the flow path cross-sectional area immediately before the venturi portion means the flow path cross-sectional area on the upstream side of the venturi portion immediately before the flow path narrows.

With the use of the venturi ejector (4310) is used, for example, when the drive gas passes through the drive gas flow path (437), a large suction force can be applied to the flow path (433) for sucking and transporting, and it is possible to prevent the flow path (433) for sucking and transporting from being clogged by the ceramic particles (432). The venturi ejector (4310) is also effective as a means for removing the ceramic particles (432) when the flow path (433) for sucking and transporting is clogged with the ceramic particles (432).

By using a compressed gas such as compressed air whose pressure has been adjusted as the drive gas, the ejection flow rate of the aerosol from the nozzle (431) can be controlled. As the drive gas, it is preferable to use dry air just like the transport gas.

Fine ceramic particles have a property of easily aggregating. However, by using the aerosol generator (430) according to the present embodiment, it is possible to eject ceramic particles having a target particle diameter distribution with suppressed aggregation.

### (Aerosol Generator According to Comparative Example)

FIG. 4D schematically shows an aerosol generator (610) according to a Comparative Example.

The aerosol generator (610) shown in FIG. 4D comprises:

a nozzle (614) for ejecting an aerosol comprising a drive gas and ceramic particles from an ejection port (614e),

a pipe (615) for sucking and transporting ceramic particles (622), which comprises an outlet (615e) for the ceramic particles at one end, the outlet (615e) communicating with an inlet (614in) of the nozzle (614),

a gas flow path (616) for flowing drive gas, which is formed coaxially on an outer perimeter of the pipe (615) so that an outlet (616e) of the drive gas communicates with an inlet (614in) of the nozzle (614), and

an accommodation unit (629) for accommodating the ceramic particles (622) and supplying the ceramic particles (622) to the pipe (615) for sucking and transporting.

The gas flow path (616) is formed between the outer peripheral surface (619) of the pipe (615) and the coaxial inner wall surface (617) having a diameter larger than the outer peripheral surface (619) of the pipe (615). The upstream side of the gas flow path (616) is connected to an introduction pipe (618), and the drive gas can flow into the gas flow path (616) through the introduction pipe (618). The drive gas flowing into the gas flow path (616) changes the direction of the flow by 90° and heads toward a drive gas outlet (616e). The inner wall surface (617) has a cylindrical portion (617a) with a constant diameter, and a tapered portion (617b) connected to the downstream side of the cylindrical portion (617a) and whose diameter gradually decreases toward the outlet (616e). The outer peripheral surface (619) of the pipe (615) has a cylindrical portion (619a) with a constant outer diameter, a diameter-expanded portion (619b) with an expanded outer diameter and connected to the downstream side of the cylindrical portion (619a), and a tapered portion (619c) whose outer diameter gradually decreases toward the outlet (615e) and connected to the downstream side of the diameter-expanded portion (619b).

In the vicinity of the drive gas outlet (616e), the clearance between the tapered portion (617b) of the inner wall surface (617) and the tapered portion (619c) of the outer peripheral surface (619) of the pipe (615) is reduced so that the gas flow path (616) is narrowed. With this configuration, the accelerated drive gas flows from the outlet (616e) of the gas flow path (616) toward the nozzle (614).

Upstream of the pipe (615), ceramic particles adjusted to a predetermined particle diameter distribution are accommodated in the accommodation unit (629). For example, a funnel can be used for the accommodation unit (629). The ceramic particles (622) in the accommodation unit (629) are sucked into the pipe (615) from an outlet (629e) provided at the bottom of the accommodation unit (629), by the suction force generated by the drive gas that flows vigorously from the outlet (616e) of the gas flow path (616) toward the inlet (614in) of the nozzle (614). At this time, the ambient gas (typically air) is also sucked from the inlet (629i) of the accommodation unit together with the ceramic particles (622) and passes through the pipe (615). After that, the ceramic particles (622) are discharged from the outlet (615e) of the pipe (615) together with the ambient gas and mixed with the drive gas. After that, the ceramic particles (622) are entrained by the drive gas, pass through the inside of the nozzle (614), and are ejected as an aerosol from the ejection port (614e).

The supply of the ceramic particles (622) to the accommodation unit (629) is not limited, but is may be carried out using, for example, a powder metering feeder (6211) such as a screw feeder and a belt conveyor. The ceramic particles (622) discharged from the powder metering feeder (6211) can be dropped into the accommodation unit (629) by gravity.

The nozzle (614) has a throat portion (614b) with a constant inner diameter, and a diffuser portion (614a) connected to the downstream side of the throat portion (614b) and whose inner diameter gradually increases toward the ejection port (614e). At the throat portion (614b), the mixing of the ceramic particles and the drive gas is promoted, and the pressure is increased at the diffuser portion (614a), and then the aerosol containing the drive gas and the ceramic particles is ejected from the ejection port (614e).

The aerosol generator (610) according to the Comparative Example uses a Coanda type ejector. In the aerosol generator (610) according to the Comparative Example, unlike the aerosol generator according to the embodiments of the present invention, the flow direction of the ceramic particles when the ceramic particles meet with the drive gas is substantially parallel to the flow direction of the drive gas. Further, unlike the aerosol generator according to the embodiments of the present invention, the aerosol generator (610) according to the Comparative Example is configured such that the drive gas meets with the ceramic particles from the outer peripheral side of the flow of the ceramic particles. As a result, it is presumed that the collision energy when the drive gas collides with the ceramic particles becomes small, so the loosening force becomes weak, and the ceramic particles are likely to be ejected from the nozzle (614) in an aggregated state.

### (First Embodiment of Particle Attaching Device)

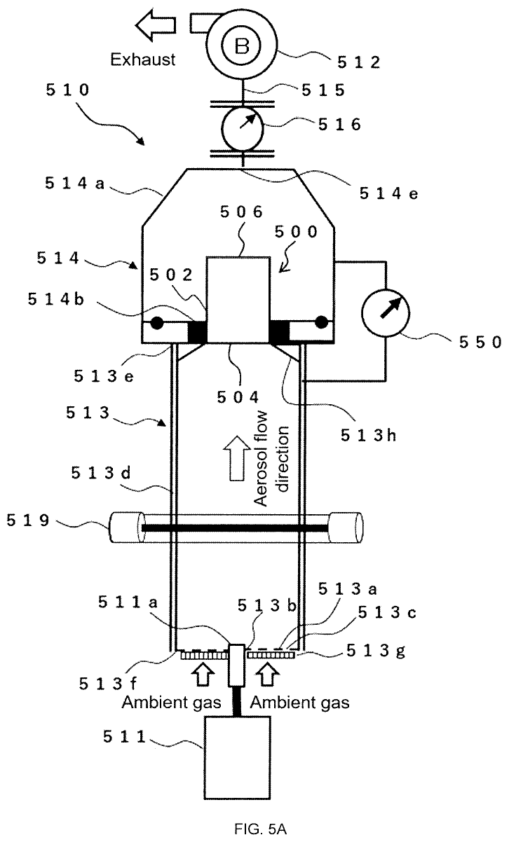

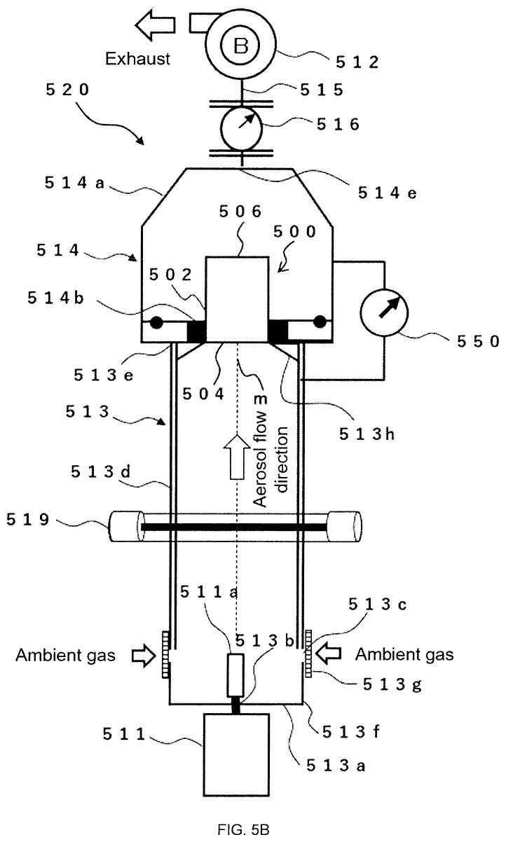

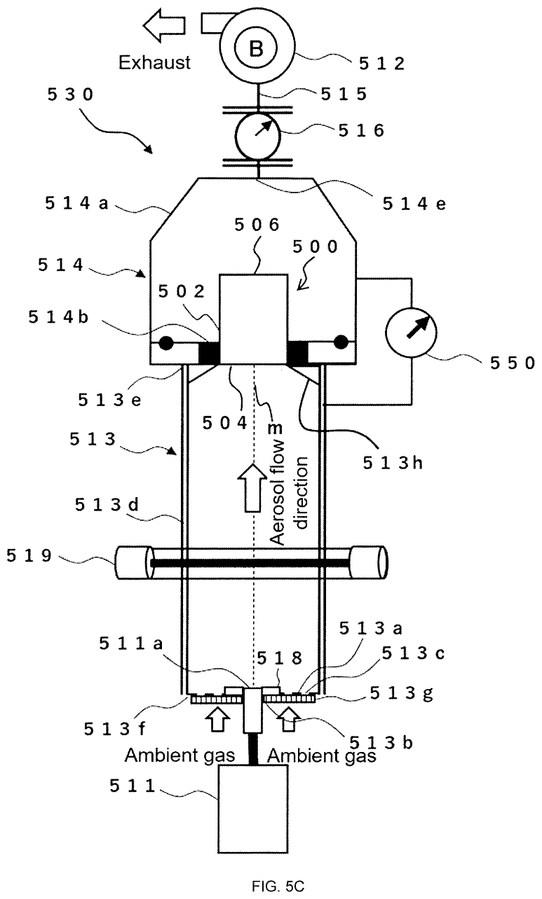

FIG. 5A schematically shows a device configuration of a first embodiment of the particle attaching device (510) suitable for carrying out the step of attaching ceramic particles to the surface of the first cells of a pillar-shaped honeycomb structure.

The particle attaching device (510) comprises:

a holder (514) for holding a pillar-shaped honeycomb structure (500),

a blower (512) for applying a suction force to the outlet side end surface (506) of the pillar-shaped honeycomb structure (500),

an aerosol generator (511) for ejecting an aerosol comprising ceramic particles toward the inlet side end surface (504) from a direction perpendicular to the inlet side end surface (504) and attaching the ceramic particles to a surface of the first cells, and

a chamber (513) provided between a nozzle (511a) of the aerosol generator (511) and the inlet side end surface (504) for guiding the aerosol through its interior.

The holder (514) is configured such that the pillar-shaped honeycomb structure (500) is held at a position where the inlet side end surface (504) faces the nozzle (511 a) of the aerosol generator (511) with the inlet side end surface (504) exposed. For example, the holder (514) can have a chuck mechanism (514b) for gripping the outer peripheral side wall (502). The chuck mechanism is not particularly limited, and a balloon chuck can be mentioned as an example. The holder (514) has a housing (514a) for rectifying the aerosol that has passed through the pillar-shaped honeycomb structure (500) in one direction without diffusing.

The side wall (513d) of the chamber (513) can be formed in a tube shape such as a cylindrical tube or a polygonal tube. The chamber (513) has an opposing surface (513a) to the inlet side end surface (504). The opposing surface (513a) to the inlet side end surface (504) has an insertion port (513b) for the nozzle (511a) of the aerosol generator (511). With this configuration, the aerosol ejected from the aerosol generator (511) can be introduced directly into the chamber (513). Typically, the downstream end (513e) of the side wall (513d) of the chamber (513) is connected to the holder (514) and the opposing surface (513a) to the inlet side end surface (504) is provided at the upstream end (513f) opposite to the downstream end (513e) of the side wall (513d) of the chamber (513).

An opening (513c) for taking in ambient gas can be provided on the side wall (513d) and/or the opposing surface (513a) to the inlet side end surface (504). Thereby, the flow rate of the gas flowing into the chamber (513) can be adjusted according to the suction force from the blower (512). However, as shown in FIG. 5A, it is preferable that the side wall (513d) of the chamber (513) be not provided with an opening (513c) for taking in ambient gas, and the ambient gas flowing into the chamber (513) be taken in only from the opening (513c) provided on the opposing surface (513a) to the inlet side end surface (504). In one embodiment, a punching plate and/or a non-woven fabric can be used for the opposing surface (513a) to the inlet side end surface (504). Further, a filter (513g) may be installed in the opening (513c) because it may entrain aggregated powder, fragments from the honeycomb, and dust.

When the cross-sectional area of the flow path of the aerosol flowing through the chamber (513) is larger than the size of the inlet side end surface (504), a tapered portion (513h) may be provided at the downstream end (513e) of the side wall (513d) so that the cross-sectional area of the flow path gradually decreases toward the inlet side end surface (504). It is preferable that the contour of the cross-section of the flow path formed by the tapered portion (513h) at the downstream end portion (513e) of the side wall (513d) match the outer peripheral contour of the inlet side end surface (504). By providing the tapered portion (513h), the ceramic particles are easily sucked into the inlet side end surface (504).

The distance L from the outlet of the nozzle (511a) to the inlet side end surface (504) of the pillar-shaped honeycomb structure (500) is preferably designed according to the area A of the inlet side end surface (504) of the pillar-shaped honeycomb structure (500). Specifically, it is preferable to increase the distance L (mm) as the area A (mm²) increases so that the aerosol tends to spread uniformly in the direction perpendicular to the flow direction of the aerosol.

By taking in the ambient gas only from the opposing surface (513a) to the inlet side end surface (504), the ambient gas flows in the same direction as the flow direction of the sprayed aerosol. Therefore, the advantage that the aerosol is stable without disturbance to the aerosol can be obtained. On the contrary, if there is an opening (513c) in the side wall (513d) of the chamber (513), the ambient gas flowing in from the opening (513c) tends to be disturbing, which is disadvantageous because the aerosol flow becomes unstable. Therefore, in a preferred embodiment, the opposing surface (513a) to the inlet side end surface (504) comprises one or more openings (513c) for taking in ambient gas into the chamber (513), and comprises no openings for taking in ambient gas into the chamber (513) other than those on the opposing surface (513a) to the inlet side end surface.

The aerosol ejected from the aerosol generator (511) passes through the inside of the chamber (513) due to the suction force from the blower (512), and then sucked into the first cells of the pillar-shaped honeycomb structure (500) from the inlet side end surface (504) of the pillar-shaped honeycomb structure (500) held on the holder (514). The ceramic particles in the aerosol sucked into the first cells attach to the surface of the first cells.

The housing (514a) of the holder (514) has an exhaust port (514e) on the downstream side of the outlet side end surface (506) of the pillar-shaped honeycomb structure (500). The exhaust port (514e) is connected to an exhaust pipe (515), and a blower (512) is provided on the downstream side thereof. Accordingly, once the aerosol from which the ceramic particles have been removed is discharged from the outlet side end surface (506) of the pillar-shaped honeycomb structure (500), it passes through the exhaust pipe (515) and then is exhausted through the blower (512). A flow meter (516) is installed in the exhaust pipe (515) so that the gas flow rate measured by the flow meter (516) can be monitored and the power of the blower (512) can be controlled according to the gas flow rate.

When the step of attaching the ceramic particles to the surface of the first cells continues, the pressure loss between the inlet side end surface and the outlet side end surface of the pillar-shaped honeycomb structure increases as the amount of the attached ceramic particles increases. Therefore, by obtaining a relationship between the amount of attached ceramic particles and the pressure loss in advance, it is possible to determine the end point of the step of attaching the ceramic particles to the surface of the first cells based on the pressure loss. Therefore, the particle attaching device (510) can be provided with a differential pressure gauge (550) for measuring the pressure loss between the inlet side end surface (504) and the outlet side end surface (506) of the pillar-shaped honeycomb structure (500), and the end point of the step may be determined based on the value of the differential pressure gauge.

When the step of attaching the ceramic particles to the surface of the first cells is carried out, the ceramic particles are also attached to the inlet side end surface (504) of the pillar-shaped honeycomb structure (500). Therefore, it is preferable to remove the ceramic particles by suction with a vacuum or the like while leveling the inlet side end surface with a jig such as a scraper.

Then, the pillar-shaped honeycomb structure filter in which the ceramic particles are attached to the surface of the first cells is heat-treated under conditions of keeping at a maximum temperature of 1000° C. or higher for 1 hour or longer, for example, 1 hour to 6 hours, typically under conditions of keeping a maximum temperature of 1100° C. to 1400° C. for 1 hour to 6 hours, to finish the pillar-shaped honeycomb structure filter. The heat treatment can be carried out, for example, by placing a pillar-shaped honeycomb structure in an electric furnace or a gas furnace. By the heat treatment, the ceramic particles are bonded to each other, and the ceramic particles are burnt on the partition walls of the first cells to form porous films on the surface of the first cells. When the heat treatment is carried out under oxygen-containing conditions such as air, a surface oxide film is formed on the surface of the ceramic particles to promote bonding between the ceramic particles. As a result, porous films that are difficult to peel off can be obtained.

A laser diffraction type particle diameter distribution measuring device (519) can be installed in the chamber (513). By installing a laser diffraction type particle diameter distribution measuring device (519), the particle diameter distribution of the ceramic particles in the aerosol ejected from the aerosol generator (511) can be measured in real time. Thereby, it is possible to monitor whether or not ceramic particles having a desired particle diameter distribution are supplied to the pillar-shaped honeycomb structure.

From the viewpoint of improving the film thickness stability of the ceramic particles attached to the surface of the first cells, the average flow velocity of the aerosol flowing in the chamber (513) in the step of attaching the ceramic particles to the surface of the first cells is preferably 0.5 m/s to 3.0 m/s, and more preferably 1.0 to 2.0 m/s.

From the viewpoint of improving the film thickness stability of the ceramic particles attached to the surface of the first cells, the lower limit of the average flow velocity of the aerosol flowing in the pillar-shaped honeycomb structure in the step of attaching the ceramic particles to the surface of the first cells is preferably 5 m/s or more, and more preferably 8 m/s or more. Further, in order to maintain a high porosity of the porous films, the upper limit of the average flow velocity of the aerosol flowing in the pillar-shaped honeycomb structure is preferably 20 m/s or less, and preferably 15 m/s or less.

### (Second Embodiment of Particle Attaching Device)

FIG. 5B schematically shows a device configuration of a second embodiment of the particle attaching device (520) suitable for carrying out the step of attaching ceramic particles to the surface of the first cells of a pillar-shaped honeycomb structure. The particle attaching device (520) according to the second embodiment is different from the particle attaching device (510) according to the first embodiment in that the openings (513c) for taking in ambient gas are provided on the side wall (513d) of the chamber (513), but not on the opposing surface (513a) to the inlet side end surface (504). In the present embodiment, the openings (513c) are provided on the upstream side from the midpoint of a line segment m connecting the center of the outlet of the nozzle (511a) of the aerosol generator (511) with the center of the inlet side end surface (504) of the pillar-shaped honeycomb structure (500). For example, they are provided on the side wall (513d) near the upstream end (513f). The openings (513c) may be provided on the downstream side from the midpoint of the line segment m, but from the viewpoint of reducing the influence of the ambient gas introduced from the side wall on the spread of the sprayed aerosol, it is desirable to provide them on the upstream side as in this embodiment. Further, in the present embodiment, a plurality of openings (513c) is provided at equal intervals along the circumferential direction of the side wall (513d). In the present embodiment, the device configuration other than the installation location of the openings (513c) is the same as that of the first embodiment, and thus the duplicate description is omitted.

### (Third Embodiment of Particle Attaching Device)

FIG. 5C schematically shows a device configuration of a third embodiment of the particle attaching device (530) suitable for carrying out the step of attaching ceramic particles to the surface of the first cells of a pillar-shaped honeycomb structure. In the particle attaching device (530) according to the third embodiment, the opposing surface (513a) of the chamber (513) comprises a concentric closure portion (518) centered on the insertion port (513b). Further, one or more openings (513c) for taking the ambient gas into the chamber (513) are provided on the outer peripheral side of the closure portion (518). The method for forming the closure portion (518) is not particularly limited, but in one embodiment, a disk-shaped plate having an insertion port (513b) for the nozzle (511a) can be used.

By providing the closure portion (518), the inflow of ambient gas from the vicinity of the nozzle (511a) of the aerosol generator (511) is prevented. On the other hand, ambient gas flows in from the vicinity of the side wall (513d) of the chamber (513). As a result, the aerosol ejected from the nozzle (511a) is drawn into the ambient gas that flows in from the opening (513c) and flows near the side wall (513d), so an advantage that the aerosol tends to spread uniformly in the direction perpendicular to the flow direction of the aerosol can be obtained. The closure portion (518) can, for example, close 50 to 87%, typically 70 to 80% of the area of the opposing surface (inner surface) (513a) of the chamber (513). Here, the area of the opposing surface (inner surface) (513a) is the area including the insertion port (513b) and the openings (513c) in addition to the non-opening portion. In the present embodiment, the device configuration other than the closure portion (518) is the same as that of the first embodiment, and thus the duplicate description is omitted.

### EXAMPLES

Hereinafter, examples for better understanding the present invention and its advantages will be illustrated, but the present invention is not limited to the examples.

### Example 1

### (1) Manufacture of Pillar-Shaped Honeycomb Structure

To 100 parts by mass of the cordierite-forming raw material, 3 parts by mass of the pore-forming material, 55 parts by mass of the dispersion medium, 6 parts by mass of the organic binder, and 1 part by mass of the dispersant were added, mixed and kneaded to prepare a green body. Alumina, aluminum hydroxide, kaolin, talc, and silica were used as the cordierite-forming raw material. Water was used as the dispersion medium, a water-absorbent polymer was used as the pore-forming material, hydroxypropyl methylcellulose was used as the organic binder, and fatty acid soap was used as the dispersant.

The green body was put into an extrusion molding machine and extruded through a die having a predetermined shape to obtain a cylindrical honeycomb formed body. The obtained honeycomb formed body was subject to dielectric-drying and hot-air drying, and then both end surfaces were cut so as to have predetermined dimensions to obtain a honeycomb dried body.

After plugging with cordierite as a material so that the first cells and the second cells were alternately arranged adjacent to each other, the obtained honeycomb dried body was degreased by heating at about 200° C. in the air atmosphere, and further fired at 1420° C. for 5 hours in the air atmosphere, thereby obtaining a pillar-shaped honeycomb structure.

The specifications of the pillar-shaped honeycomb structure are as follows.

Overall shape: cylindrical shape with a diameter of 132 mm and a height of 120 mm

Cell shape in a cross-section perpendicular to the cell flow path direction: square

Cell density (number of cells per unit cross-sectional area): 200 cpsi

Partition wall thickness: 0.2 mm (nominal value based on die specifications)

### (2) Attachment of Ceramic Particles to Pillar-Shaped Honeycomb Structure

To the pillar-shaped honeycomb structure produced above, using the particle attaching device having the configuration shown in FIG. 5A, an aerosol containing ceramic particles was ejected toward the center of the inlet side end surface of the pillar-shaped honeycomb structure from the direction perpendicular to the inlet side end surface so that the ceramic particles were attached to the surface of the first cells. The specifications and operating conditions of the particle attaching device were as follows.

Chamber

Shape: cylindrical

Inner diameter: 300 mm

Length: 600 mm

Ambient gas: air

Opening position for taking in ambient gas: only on the opposing surface to the inlet side end surface of the pillar-shaped honeycomb structure

Structure of the opposing surface: punching plate

Installation of filter in the openings: Yes

Aerosol generator nozzle position: center of the opposing surface

Distance L from the nozzle outlet of the aerosol generator to the inlet side end surface of the pillar-shaped honeycomb structure: 600 mm

Aerosol Generator

Product name: RBG2000 manufactured by PALAS (with the structure shown in FIG. 4A)

Type: batch type aerosol generator

Rotating body: rotating brush

Type of the ceramic particles accommodated in the cylinder: SiC particles

Volume-based particle diameter distribution of the ceramic particles accommodated in the cylinder (measured by laser diffraction/scattering method): median diameter (D50)=3 μm, SiC particles with particle diameter of 10 μm or more: ≤20% by volume

Drive gas: compressed dry air (dew point 10° C. or less)

Presence/absence of venturi portion: Absence

Flow velocity of the drive gas immediately before the drive gas passes through the supply port of the drive gas flow path: 15 m/sec (measured by Anemomaster (manufacturer: KANOMAX model: 6162)) (All Anemomasters described below used this device.)

Average flow velocity of the aerosol ejected from the nozzle: 20 m/s (measured by Anemomaster at a position 10 to 20 mm on the downstream side from the nozzle)

Average flow rate of the aerosol ejected from the nozzle: 35 L/min (measured by a flow meter)

Mass flow rate of the ceramic particles in the aerosol ejected from the nozzle: 0.1 g/s (measured by a flow meter)

Aerosol generator nozzle inner diameter: 8 mm

Laser Diffraction Type Particle Diameter Distribution Measuring Device

Product name: Insitec Spray manufactured by Malvern

Installation location: inside the chamber

Operating Conditions

Blower suction flow rate: 4000 L/min

Average flow velocity of the aerosol flowing in the chamber: 2 m/s (measured by Anemomaster)

Average flow velocity of the aerosol flowing in the pillar-shaped honeycomb structure: approximately 10 m/s (calculated by flow rate/cell opening area)

End point of step of attaching the ceramic particles: when the differential pressure gauge value reaches +0.1 kPa to +0.4 kPa (the differential pressure value varies because the film mass is set depending on the product volume).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and the partition walls of the pillar-shaped honeycomb structure filter obtained by the above manufacturing method were measured by cross-sectional SEM observation based on the method described above. The device used for the measurement was FE-SEM (model: ULTRA55 (manufactured by ZEISS)), and the observation magnification was ×1000. In addition, the measurement was performed in an arbitrary five or more fields of view, and the average value was used as the measured value. As the image analysis software, HALCON-version 11.0.5 of Lynx Co., Ltd. was used. The results are shown in Table 1.

### (6) Quality Stability

With respect to ten pillar-shaped honeycomb structure filters obtained by the above manufacturing method, the thickness of the porous films was investigated at a position of 95 mm in the longitudinal direction from the center of gravity of the inlet side end surface of the pillar-shaped honeycomb structure filter, which was a portion where the thickness of the porous films was likely to fluctuate. The thickness was measured with a three-dimensional measuring machine (model VR-3200 or VR-5200) manufactured by KEYENCE, and the coefficient of variation (=standard deviation/arithmetic mean) was determined. The results were evaluated as follows. The results are shown in Table 1.

A: The coefficient of variation was less than 0.20

B: The coefficient of variation was 0.21 or more and 0.40 or less

C: The coefficient of variation exceeded 0.41

### Example 2

### (1) Manufacture of Pillar-Shaped Honeycomb Structure

A pillar-shaped honeycomb structure was obtained under the same manufacturing conditions as in Example 1.

### (2) Attachment of Ceramic Particles to Pillar-Shaped Honeycomb Structure

To the pillar-shaped honeycomb structure produced above, using the particle attaching device having the configuration shown in FIG. 5B, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were as follows.

Chamber

Shape: cylindrical

Inner diameter: 300 mm

Length: 600 mm

Ambient gas: air

Opening position for taking in ambient gas: a punching metal plate with an opening ratio of 50% was installed along the circumferential direction of the chamber side wall at a position (the position of the center of each opening) approximately 100 mm downstream from the upstream end of the chamber side wall.

Installation of filter in the openings: Yes

Aerosol generator nozzle position: center of the opposing surface to the inlet side end surface

Distance L from the nozzle outlet of the aerosol generator to the inlet side end surface of the pillar-shaped honeycomb structure: 600 mm

Aerosol Generator

Product name: BEG1000 manufactured by PALAS (with the structure shown in FIG. 4C)

Type: continuous type aerosol generator

Connection method of the drive gas flow path and the flow path for sucking and transferring: venturi ejector

Place where the ceramic particle supply port was installed: on the downstream side of the narrowest location of the venturi portion and adjacent to this location

Transporting speed of the ceramic particles by the belt feeder: 1.0 g/s

Rotating body: rotating brush

Type of the ceramic particles accommodated in the accommodation unit: SiC particles

Volume-based particle diameter distribution of the ceramic particles accommodated in the accommodation unit (measured by laser diffraction/scattering method): median diameter (D50)=3 μm, SiC particles with particle diameter of 10 μm or more: ≤20% by volume

Drive gas: compressed dry air (dew point 10° C. or less)

Transport gas: compressed dry air (dew point 10° C. or less)

Average flow rate of the transport gas before meeting with the drive gas: 50 L/min (measured by a flow meter)

Average flow rate of the drive gas before meeting with the transport gas: 100 L/min (measured by a flow meter)

Flow velocity of the drive gas immediately before the drive gas passes through the venturi portion: 26 m/sec (measured by Anemomaster)

Ratio of the flow path cross-sectional area immediately before the venturi portion to the flow path cross-sectional area of the venturi portion=1:0.028

Average flow velocity of the aerosol ejected from the nozzle: 50 m/s (measured by Anemomaster at a position 10 to 20 mm on the downstream side from the nozzle)

Average flow rate of the aerosol ejected from the nozzle: 150 L/min (measured by a flow meter)

Mass flow rate of the ceramic particles in the aerosol ejected from the nozzle: 0.5 g/s (measured by a flow meter)

Aerosol generator nozzle inner diameter: 8 mm

Laser Diffraction Type Particle Diameter Distribution Measuring Device

Product name: Insitec Spray manufactured by Malvern

Installation location: inside the chamber

Operating Conditions

Blower suction flow rate: 4000 L/min

Average flow velocity of the aerosol flowing in the chamber: 1 m/s (measured by Anemomaster)

Average flow velocity of the aerosol flowing in the pillar-shaped honeycomb structure: approximately 10 m/s (calculated by flow rate/cell opening area)

End point of step of attaching ceramic particles: when the differential pressure gauge value reaches +0.1 kPa to +0.4 kPa (the differential pressure value varies because the film mass is set depending on the product volume).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### Example 3

### (1) Manufacture of Pillar-Shaped Honeycomb Structure

A pillar-shaped honeycomb structure was obtained under the same manufacturing conditions as in Example 1 except that the overall shape was changed to an elliptical cylindrical shape having a major axis of 231 mm, a minor axis of 106 mm, and a height of 120 mm.

### (2) Attachment of Ceramic Particles to Pillar-Shaped Honeycomb Structure

To the pillar-shaped honeycomb structure produced above, using the particle attaching device having the configuration shown in FIG. 5A, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were as follows.

Chamber

Shape: cylindrical

Inner diameter: 300 mm

Length: 600 mm

Ambient gas: air

Opening position for taking in ambient gas: only on the opposing surface to the inlet side end surface of the pillar-shaped honeycomb structure

Structure of the opposing surface to the inlet side end surface: punching plate

Installation of filter in the openings: Yes

Aerosol generator nozzle position: center of the opposing surface

Distance L from the nozzle outlet of the aerosol generator to the inlet side end surface of the pillar-shaped honeycomb structure: 600 mm

Aerosol Generator

Product name: BEG1000 manufactured by PALAS (with the structure shown in FIG. 4C)

Type: continuous type aerosol generator

Connection method of the drive gas flow path and the flow path for sucking and transferring: venturi ejector

Place where the ceramic particle supply port was installed: on the downstream side of the narrowest location of the venturi portion and adjacent to this location

Transporting speed of the ceramic particles by the belt feeder: 0.5 g/s

Rotating body: rotating brush

Type of the ceramic particles accommodated in the accommodation unit: SiC particles

Volume-based particle diameter distribution of the ceramic particles accommodated in the accommodation unit (measured by laser diffraction/scattering method): median diameter (D50)=3 μm, SiC particles with particle diameter of 10 μm or more: ≤20% by volume

Drive gas: compressed dry air (dew point 10° C. or less)

Transport gas: compressed dry air (dew point 10° C. or less)

Average flow rate of the transport gas before meeting with the drive gas: 80 L/min (measured by a flow meter)

Average flow rate of the drive gas before meeting with the transport gas: 80 L/min (measured by a flow meter)

Flow velocity of the drive gas immediately before the drive gas passes through the venturi portion: 26 m/sec (measured by Anemomaster)

Ratio of the flow path cross-sectional area immediately before the venturi portion to the flow path cross-sectional area of the venturi portion=1:0.05

Average flow velocity of the aerosol ejected from the nozzle: 18 m/s (measured by Anemomaster at a position 10 to 20 mm on the downstream side of the nozzle)

Average flow rate of the aerosol ejected from the nozzle: 160 L/min (measured by a flow meter)

Mass flow rate of the ceramic particles in the aerosol ejected from the nozzle: 0.5 g/s (measured by a flow meter)

Aerosol generator nozzle inner diameter: 12 mm

Laser Diffraction Type Particle Diameter Distribution Measuring Device

Product name: Insitec Spray manufactured by Malvern

Installation location: inside the chamber

Operating Conditions

Blower suction flow rate: 4000 L/min

Average flow velocity of the aerosol flowing in the chamber: 1 m/s (measured by Anemomaster)

Average flow velocity of the aerosol flowing in the pillar-shaped honeycomb structure: approximately 7 m/s (calculated by flow rate/cell opening area)

End point of step of attaching ceramic particles: when the differential pressure gauge value reaches +0.1 kPa to +0.4 kPa (the differential pressure value varies because the film mass is set depending on the product volume).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### Example 4

### (1) Manufacture of Pillar-Shaped Honeycomb Structure

A pillar-shaped honeycomb structure was obtained under the same manufacturing conditions as in Example 1 except that the overall shape was changed to an elliptical cylindrical shape having a major axis of 235 mm, a minor axis of 146 mm, and a height of 120 mm.

### (2) Attachment of Ceramic Particles to Pillar-Shaped Honeycomb Structure

To the pillar-shaped honeycomb structure produced above, using the particle attaching device having the configuration shown in FIG. 5A, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were the same as those in Example 3 except that the length of the chamber was set to 1600 mm. In Example 4, since the cell opening area of the pillar-shaped honeycomb structure was different from that of Example 3, the average flow velocity of the aerosol flowing in the pillar-shaped honeycomb structure was about 5 m/s (calculated by flow rate/cell opening area).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### Example 5

### (1) Manufacture of Pillar-Shaped Honeycomb Structure

A pillar-shaped honeycomb structure was obtained under the same manufacturing conditions as in Example 3.

### (2) Attachment of Ceramic Particles to Pillar-Shaped Honeycomb Structure

To the pillar-shaped honeycomb structure produced above, using the particle attaching device having the configuration shown in FIG. 5C, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were as follows.

The specifications and operating conditions of the particle attaching device were the same as in Example 3 except that a disk-shaped plate with a diameter of 150 mm and having an insertion port for inserting the nozzle of the aerosol generator with the insertion port at the center was fixed to the opposing surface to the inlet side end surface of the pillar-shaped honeycomb structure. The disk-shaped plate closed 20% of the area of the opposing surface (inner surface).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### Example 6

### (1) Manufacture of Pillar-Shaped Honeycomb Structure

A pillar-shaped honeycomb structure was obtained under the same manufacturing conditions as in Example 3.

### (2) Attachment of Ceramic Particles to Pillar-Shaped Honeycomb Structure

To the pillar-shaped honeycomb structure produced above, using the particle attaching device having the configuration shown in FIG. 5A, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were as follows.

Chamber

Shape: cylindrical

Inner diameter: 300 mm

Length: 600 mm

Ambient gas: air

Opening position for taking in ambient gas: only on the opposing surface to the inlet side end surface of the pillar-shaped honeycomb structure

Structure of the opposing surface to the inlet side end surface: punching plate

Installation of filter in the openings: Yes

Aerosol generator nozzle position: center of the opposing surface

Distance L from the nozzle outlet of the aerosol generator to the inlet side end surface of the pillar-shaped honeycomb structure: 600 mm

Aerosol Generator

Product name: none (manufactured in-house) (with the structure shown in FIG. 4B)

Type: continuous type aerosol generator

Connection method of the drive gas flow path and the flow path for sucking and transferring: venturi ejector

Place where the ceramic particle supply port was installed: on the downstream side of the narrowest location of the venturi portion and adjacent to this location

Method of supplying the ceramic particles to the accommodation unit: screw feeder

Type of the accommodation unit: funnel

Type of the ceramic particles accommodated in the accommodation unit: SiC particles

Volume-based particle diameter distribution of the ceramic particles accommodated in the accommodation unit (measured by laser diffraction/scattering method): median diameter (D50)=3 μm, SiC particles with particle diameter of 10 μm or more: ≤20% by volume

Drive gas: compressed dry air (dew point 10° C. or less)

Ambient gas sucked: Air

Average flow rate of the ambient gas flowing through the flow path for sucking and transporting: 40 L/min

Average flow rate of the drive gas flowing through the drive gas flow path before meeting with the sucked ambient gas: 80 L/min.

Flow velocity of the drive gas immediately before the drive gas passes through the venturi portion: 26 m/sec (measured by Anemomaster)

Ratio of the flow path cross-sectional area immediately before the venturi portion to the flow path cross-sectional area of the venturi portion=1:0.028

Average flow velocity of the aerosol ejected from the nozzle: 26 m/s (measured by Anemomaster at a position 10 to 20 mm on the downstream side of the nozzle)

Average flow rate of the aerosol ejected from the nozzle: 120 L/min (measured by a flow meter)

Mass flow rate of the ceramic particles in the aerosol ejected from the nozzle: 0.5 g/s (measured by a flow meter)

Aerosol generator nozzle inner diameter: 12 mm

Laser Diffraction Type Particle Diameter Distribution Measuring Device

Product name: Insitec Spray manufactured by Malvern

Installation location: inside the chamber

Operating Conditions

Blower suction flow velocity: 4000 L/min

Average flow velocity of the aerosol flowing in the chamber: 1 m/s (measured by Anemomaster)

Average flow velocity of the aerosol flowing in the pillar-shaped honeycomb structure: approximately 7 m/s (calculated by flow rate/cell opening area)

End point of step of attaching ceramic particles: when the differential pressure gauge value reaches +0.1 kPa to +0.4 kPa (the differential pressure value varies because the film mass is set depending on the product volume).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### Comparative Example 1

### (1) Manufacture of Pillar-Shaped Honeycomb Structure

A pillar-shaped honeycomb structure was obtained under the same manufacturing conditions as in Example 1.

### (2) Attachment of Ceramic Particles to Pillar-Shaped Honeycomb Structure

To the pillar-shaped honeycomb structure produced above, using the particle attaching device having the configuration shown in FIG. 5A, an aerosol containing ceramic particles was ejected toward the center of the inlet side end surface of the pillar-shaped honeycomb structure from the direction perpendicular to the inlet side end surface such that the ceramic particles were attached to the surface of the first cells. The specifications and operating conditions of the particle attaching device were as follows.

Chamber

Shape: cylindrical

Inner diameter: 300 mm

Length: 600 mm

Ambient gas: air

Opening position for taking in ambient gas: only on the opposing surface to the inlet side end surface of the pillar-shaped honeycomb structure

Structure of the opposing surface to the inlet side end surface: punching plate

Installation of filter in the openings: Yes

Aerosol generator nozzle position: center of the opposing surface

Distance L from the nozzle outlet of the aerosol generator to the inlet side end surface of the pillar-shaped honeycomb structure: 600 mm

Aerosol Generator

Product name: Model VRL50-080608 manufactured by PISCO (with the structure shown in FIG. 4D)

Type: continuous type aerosol generator

Connection method of the drive gas flow path and the flow path for sucking and transferring: Coanda type ejector

Method of supplying the ceramic particles to the accommodation unit: screw feeder

Type of the accommodation unit: funnel

Type of the ceramic particles accommodated in the accommodation unit: SiO₂ particles

Volume-based particle diameter distribution of the ceramic particles accommodated in the accommodation unit (measured by laser diffraction/scattering method): median diameter (D50)=50 μm (aggregation of 100 μm or more occurs frequently)

Drive gas: compressed dry air (dew point 10° C. or less)

Ambient gas sucked: Air

Average flow rate of the ambient gas flowing through the pipe for sucking and transporting: 4000 L/min (measured by a flow meter)

Average flow rate of the drive gas flowing through the drive gas flow path before meeting with the sucked ambient gas: 35 L/min (measured by a flow meter)

Average flow velocity of the aerosol ejected from the nozzle: 20 m/s (measured by Anemomaster at a position 10 to 20 mm on the downstream side of the nozzle)

Average flow rate of the aerosol ejected from the nozzle: 35 L/min (measured by a flow meter)

Mass flow rate of the ceramic particles in the aerosol ejected from the nozzle: 0.1 g/s (measured by a flow meter)

Aerosol generator nozzle inner diameter: 8 mm

Laser Diffraction Type Particle Diameter Distribution Measuring Device

Product name: Insitec Spray manufactured by Malvern

Installation location: inside the chamber

Operating Conditions

Blower suction flow velocity: 4000 L/min

Average flow velocity of the aerosol flowing in the chamber: 1 m/s (measured by Anemomaster)

Average flow velocity of the aerosol flowing in the pillar-shaped honeycomb structure: approximately 10 m/s (calculated by flow rate/cell opening area)

End point of step of attaching ceramic particles: when the differential pressure gauge value reaches +0.1 kPa to +0.4 kPa (the differential pressure value varies because the film mass is set depending on the product volume).

### (3) Measurement of Particle Diameter Distribution of Ceramic Particles in Aerosol

While the particle attaching device was in operation, a laser diffraction type particle diameter distribution measuring device measured the volume-based particle diameter distribution of the ceramic particles in the aerosol ejected from the aerosol generator, and the median diameter (D50) and the ratio of the ceramic particles having a particle diameter of 10 μm or more were determined. The results are shown in Table 1.

### (4) Formation of Porous Films

With respect to the pillar-shaped honeycomb structure thus obtained to which the ceramic particles were attached, the ceramic particles attached to the inlet side end surface were sucked and removed by vacuum while the inlet side end surface was leveled with a scraper. After that, the pillar-shaped honeycomb structure was placed in an electric furnace and heat-treated in an air atmosphere under the conditions of keeping it at a maximum temperature of 1200° C. for 2 hours to form porous films on the surface of the first cells, thereby obtaining a pillar-shaped honeycomb structure filter. From the mass change before and after the attaching of the ceramic particles, it was confirmed that the mass of the porous films formed on the pillar-shaped honeycomb structure was 2 g/L to 10 g/L with respect to the product volume. In addition, a necessary number of pillar-shaped honeycomb structure filters were prepared to carry out the following characteristic evaluation.

### (5) Porosity and Average Pore Diameter

The porosity and average pore diameter of the porous films and partition walls of the pillar-shaped honeycomb structure filter obtained by the above manufacturing method were measured by the same method as in Example 1. The results are shown in Table 1.

### (6) Quality Stability

For ten pillar-shaped honeycomb filters obtained by the above manufacturing method, the coefficient of variation of the thickness of the porous films was determined in the same manner as in Example 1. The results are shown in Table 1.

### <Discussion>

In Comparative Example 1 in which the structure of the aerosol generator was inappropriate, the ceramic particles in the aerosol were coarse. On the other hand, in Examples 1 to 6 in which the structure of the aerosol generator was appropriate, the ceramic particles in the aerosol were fine. This is because the aerosol generators of Examples 1 to 6 were able to suppress the aggregation of ceramic particles.

Further, in Examples 1, 3 to 6 of the particle attaching device, since the openings for taking in the ambient gas was provided such that it faced the inlet side end surface, the quality stability was improved as compared with Example 2 in which the openings for taking in the ambient gas was provided on the side wall.

TABLE 1

| | | | | | | | Comparative |
|---|---|---|---|---|---|---|---|
| | Example 1 | Example 2 | Example 3 | Example 4 | Example 5 | Example 6 | Example 1 |
| 1. Device configuration | | | | | | | |
| Aerosol generator | FIG. 4A | FIG. 4C | FIG. 4C | FIG. 4C | FIG. 4C | FIG. 4B | FIG. 4D |
| Particle attaching device | FIG. 5A | FIG. 5B | FIG. 5A | FIG. 5A | FIG. 5C | FIG. 5A | FIG. 5A |
| 2. Ceramic particles in aerosol | | | | | | | |
| Material of ceramic particles | Silicon | Silicon | Silicon | Silicon | Silicon | Silicon | Silica |
| | carbide | carbide | carbide | carbide | carbide | carbide | |
| Median diameter (D50) (μm) | 3.1 | 3.2 | 3.2 | 3.2 | 3.0 | 3.0 | 50.0 |
| Volume ratio (%) of particles | 10 | 10 | 10 | 10 | 10 | 10 | 70 |
| of 10 μm or more | | | | | | | |
| 3. Characteristics of pillar-shaped | | | | | | | |
| honeycomb structure filter | | | | | | | |
| <Partition walls> | | | | | | | |
| Porosity (%) | 55.0 | 55.0 | 55.0 | 55.0 | 55.0 | 55.0 | 55.0 |
| Average pore diameter (μm) | 8.8 | 8.8 | 8.8 | 8.8 | 8.8 | 8.8 | 8.8 |
| <Porous films> | | | | | | | |
| Porosity (%) | 70 | 70 | 70 | 70 | 70 | 70 | 70 |
| Average pore diameter (μm) | 3.5 | 3.5 | 3.5 | 3.5 | 3.5 | 3.5 | 3 to 5 |
| 4. Quality stability | 0.24 | 0.38 | 0.29 | 0.29 | 0.29 | 0.27 | 0.27 |

### DESCRIPTION OF REFERENCE NUMERALS

100 Pillar-shaped honeycomb structure filter
102 Outer peripheral side wall
104 Inlet side end surface
106 Outlet side end surface
108 First cell
109 Plugged portion
110 Second cell
112 Partition wall
114 Porous film
410 Aerosol generator
411 Nozzle
412 Ceramic particles
413 Cylinder
413e Cylinder outlet
414 Piston or screw
415 Loosening chamber
415i Inlet
415e Outlet
416 Rotating body
417 Drive gas flow path
417i Supply port
420 Aerosol generator
421 Nozzle
422 Ceramic particles
423 Flow path
423e Outlet
427 Drive gas flow path
427i Supply port
427v Venturi portion
429 Accommodation unit
429i Inlet
429e Outlet
4210 Venturi ejector
4211 Powder metering feeder
430 Aerosol generator
431 Nozzle
432 Ceramic particles
433 Flow path
433i Inlet
433e Outlet
434 Belt feeder
435 Loosening chamber
435in Inlet
435e Outlet
436 Rotating body
437 Drive gas flow path
437i Supply port
437v Venturi portion
438 Stirrer
439 Accommodation unit
439e Discharge port
4310 Venturi ejector
500 Pillar-shaped honeycomb structure
502 Outer peripheral side wall
504 Inlet side end surface
506 Outlet side end surface
510 Particle attaching device
511 Aerosol generator
511a Nozzle
512 Blower
513 Chamber
513a Opposing surface to the inlet side end surface
513b Insertion port
513c Opening
513d Side wall
513e Downstream end
513f Upstream end
513g Filter
513h Tapered portion
514 Holder
514a Housing
514b Chuck mechanism
514e Exhaust port
515 Exhaust pipe
516 Flow meter
518 Closure portion
519 Laser diffraction type particle diameter distribution measuring device
520 Particle attaching device
530 Particle attaching device
550 Differential pressure gauge
610 Aerosol generator
614 Nozzle
614a Diffuser portion
614b Throat portion
614in Inlet
614e Ejection port
615 Pipe
615e Outlet
616 Gas flow path
616e Outlet
617 Inner wall surface
617a Cylindrical portion
617b Tapered portion
618 Introduction pipe
619 Outer peripheral surface
619a Cylindrical portion
619b Diameter-expanded portion
619c Tapered portion
622 Ceramic particles
629 Accommodation unit
629i Inlet
629e Outlet
6211 Powder metering feeder

1. A method for manufacturing a pillar-shaped honeycomb structure filter, comprising:
a step of preparing a pillar-shaped honeycomb structure comprising a plurality of first cells extending from an inlet side end surface to an outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, the plurality of first cells and the plurality of second cells alternately arranged adjacent to each other with a porous partition wall interposed therebetween, and
a step of attaching ceramic particles to a surface of the first cells by ejecting an aerosol comprising the ceramic particles toward the inlet side end surface from a direction perpendicular to the inlet side end surface while applying a suction force to the outlet side end surface to suck the ejected aerosol from the inlet side end surface;
wherein the ejection of the aerosol is carried out using an aerosol generator comprising a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol.

2. The method according to claim 1, wherein the ceramic particles in the aerosol have a median diameter (D50) of 1.0 to 6.0 μm in a volume-based cumulative particle diameter distribution measured by a laser diffraction/scattering method.

3. The production method according to claim 1, wherein as for the ceramic particles in the aerosol, in a volume-based particle diameter frequency distribution measured by the laser diffraction/scattering method, the ceramic particles of 10 μm or more is 20% by volume or less.

4. The method according to claim 1, wherein
the aerosol ejected from the nozzle passes through a chamber provided between the nozzle and the inlet side end surface and is sucked from the inlet side end surface,
the chamber comprises an opposing surface to the inlet side end surface,
the opposing surface comprises an insertion port for the nozzle and one or more openings for taking in ambient gas into the chamber, and
the chamber comprises no openings for taking in ambient gas other than those on the opposing surface.

5. The method according to claim 4, wherein the opposing surface of the chamber comprises a concentric closure portion centered on the insertion port, and the one or more openings are provided on an outer peripheral side of the closure portion.

6. The method according to claim 1, wherein the aerosol generator further comprises:
a cylinder for accommodating the ceramic particles,
a piston or a screw for sending out the ceramic particles accommodated in the cylinder from a cylinder outlet, and
a loosening chamber comprising an inlet communicating with the cylinder outlet, a rotating body for loosening the ceramic particles sent out from the cylinder outlet, and an outlet communicating with the supply port.

7. The method according to claim 1, wherein the aerosol generator further comprises:
a flow path for sucking and transporting the ceramic particles, which comprises an outlet communicating with the supply port, and
an accommodation unit for accommodating the ceramic particles and supplying the ceramic particles to the flow path for sucking and transporting;
wherein the drive gas flow path comprises on the way thereof a venturi portion where the flow path is narrowed, and the supply port is provided on the downstream side of the narrowest flow path location in the venturi portion.

8. The method according to claim 1, wherein the aerosol generator further comprises:
a flow path for sucking and transporting the ceramic particles, which comprises an outlet communicating with the supply port,
a belt feeder for transporting the ceramic particles, and
a loosening chamber comprising an inlet for receiving the ceramic particles transported from the belt feeder, a rotating body for loosening the received ceramic particles, and an outlet communicating with the flow path for sucking and transporting.

9. The method according to claim 1, wherein an end point of the step of attaching the ceramic particles to the surface of the first cells is determined based on a value of a differential pressure gauge installed for measuring a pressure loss between the inlet side end surface and the outlet side end surface of the pillar-shaped honeycomb structure.

10. The method according to claim 1, wherein in the step of attaching the ceramic particles to the surface of the first cells, an average flow velocity of the aerosol flowing inside the pillar-shaped honeycomb structure is 5 m/s or more.

11. The method according to claim 1, wherein a main component of the ceramic particles is silicon carbide, alumina, silica, cordierite or mullite.

12. A particle attaching device for a pillar-shaped honeycomb structure, comprising:
a holder for holding the pillar-shaped honeycomb structure comprising a plurality of first cells extending from an inlet side end surface to an outlet side end surface, each opening on the inlet side end surface and having a plugged portion on the outlet side end surface, and a plurality of second cells extending from the inlet side end surface to the outlet side end surface, each having a plugged portion on the inlet side end surface and opening on the outlet side end surface, the plurality of first cells and the plurality of second cells alternately arranged adjacent to each other with a porous partition wall interposed therebetween,
a blower for applying a suction force to the outlet side end surface of the pillar-shaped honeycomb structure, and
an aerosol generator for ejecting an aerosol comprising ceramic particles toward the inlet side end surface from a direction perpendicular to the inlet side end surface and attaching the ceramic particles to a surface of the first cells;
wherein the aerosol generator comprises a drive gas flow path for flowing a pressurized drive gas, a supply port provided on the way of the drive gas flow path and capable of sucking the ceramic particles from an outer peripheral side of the drive gas flow path toward an inside of the drive gas flow path, and a nozzle attached to a tip of the drive gas flow path and capable of ejecting the aerosol.

13. The particle attaching device for a pillar-shaped honeycomb structure according to claim 12, further comprising a chamber provided between the nozzle and the inlet side end surface for guiding the aerosol through its interior, wherein
the chamber comprises an opposing surface to the inlet side end surface,
the opposing surface comprises an insertion port for the nozzle and one or more openings for taking in ambient gas into the chamber, and
the chamber comprises no openings for taking in ambient gas other than those on the opposing surface.

14. The particle attaching device for a pillar-shaped honeycomb structure according to claim 13, wherein the opposing surface comprises a concentric closure portion centered on the insertion port, and the one or more openings are provided on an outer peripheral side of the closure portion.

15. The particle attaching device for a pillar-shaped honeycomb structure according to claim 1, wherein the aerosol generator further comprises:
a cylinder for accommodating the ceramic particles,
a piston or a screw for sending out the ceramic particles accommodated in the cylinder from a cylinder outlet, and
a loosening chamber comprising an inlet communicating with the cylinder outlet, a rotating body for loosening the ceramic particles sent out from the cylinder outlet, and an outlet communicating with the supply port.

16. The particle attaching device for a pillar-shaped honeycomb structure according to claim 1, wherein the aerosol generator further comprises:
a flow path for sucking and transporting the ceramic particles, which comprises an outlet communicating with the supply port, and
an accommodation unit for accommodating the ceramic particles and supplying the ceramic particles to the flow path for sucking and transporting;
wherein the drive gas flow path comprises on the way thereof a venturi portion where the flow path is narrowed, and the supply port is provided on the downstream side of the narrowest flow path location in the venturi portion.

17. The particle attaching device for a pillar-shaped honeycomb structure according to claim 1, wherein the aerosol generator further comprises:
a flow path for sucking and transporting the ceramic particles, which comprises an outlet communicating with the supply port,
a belt feeder for transporting the ceramic particles, and
a loosening chamber comprising an inlet for receiving the ceramic particles transported from the belt feeder, a rotating body for loosening the received ceramic particles, and an outlet communicating with the flow path for sucking and transporting.

18. The method according to claim 4, wherein the average flow velocity of the aerosol flowing in the chamber in the step of attaching the ceramic particles to the surface of the first cells is 0.5 m/s to 3.0 m/s.
